(19) United States
(12) Patent Application Publication
(10) Pub. No.: US 2025/0225708 A1
(43) Pub. Date: Jul. 10, 2025

(54) VIRTUAL OBJECT CONTROL METHOD AND APPARATUS, ELECTRONIC DEVICE, AND STORAGE MEDIUM

(71) Applicant: Tencent Technology (Shenzhen) Company Limited, Shenzhen (CN)

(72) Inventor: Yan Wang, Shenzhen (CN)

(21) Appl. No.: 19/065,509

(22) Filed: Feb. 27, 2025

Related U.S. Application Data
(63) Continuation of application No. PCT/CN2024/070112, filed on Jan. 2, 2024.

(30) Foreign Application Priority Data
Mar. 2, 2023 (CN) 202310245141.9

(51) Int. Cl. G06T 13/40

(52) U.S. Cl. CPC G06T 13/40

(57) ABSTRACT

A virtual object control method and apparatus, an electronic device, and a storage medium are provided. A virtual object is split into a plurality of parts, a part bone resource is loaded for each part, and the part is independently controlled by using part animation information to perform an animation behavior. However, the part animation information inherits whole-body animation information, so that the animation behavior of each part is kept consistent with an animation behavior of a whole body. An appearance resource is loaded in units of parts. Pose adaptation is performed on the appearance resource by using the part animation information, and then the appearance resources of the parts are assembled to form an appearance resource of the whole body of the virtual object.

### RELATED APPLICATIONS

This application is a continuation application of PCT Patent Application No. PCT/CN2024/070112, filed Jan. 2, 2024, which claims priority to Chinese Patent Application No. 202310245141.9, filed on Mar. 2, 2023, each entitled “VIRTUAL OBJECT CONTROL METHOD AND APPARATUS, ELECTRONIC DEVICE, AND STORAGE MEDIUM,” and each of which is incorporated herein by reference in its entirety.

### FIELD

The present disclosure relates to the field of computer technologies, and in particular, to a virtual object control method and apparatus, an electronic device, and a storage medium.

### BACKGROUND

With the development of computer technologies, a user can open a game application on a terminal at any time to play a game. A virtual scene is provided in the game application, and a user can control a virtual object to perform an activity in the virtual scene. The same virtual object may show different external images by wearing different skins.

In a process of displaying a game picture frame in real time in a game application, appearance resources of all virtual objects within a field of view need to be loaded in each frame, and the appearance resource of each virtual object is controlled to change with a bone pose of the virtual object.

### SUMMARY

Embodiments of the present disclosure provide a virtual object control method and apparatus, an electronic device, and a storage medium, which can improve loading efficiency of a virtual object, shorten rendering time, and reduce a probability of stuttering. The solutions are as follows.

In one aspect, a virtual object control method is provided, including:
loading, by an electronic device, a whole-body bone resource of a virtual object and a part bone resource of each of a plurality of parts;
configuring, by the electronic device for each part, part animation information of the part bone resource of the part based on whole-body animation information of the whole-body bone resource, the part animation information inheriting an animation behavior of the part in the whole-body animation information;
loading, by the electronic device, an appearance resource of the part based on appearance resource indication information of the part, the appearance resource indication information indicating the appearance resource of the part; and
concealing, by the electronic device, the whole-body bone resource, and controlling, based on the part animation information, the appearance resource to perform an animation behavior following the part bone resource.

In another one aspect, a virtual object control apparatus is provided, including:
a bone resource loading module, configured to load a whole-body bone resource of a virtual object and a part bone resource of each of a plurality of parts;
a configuration module, configured to configure, for each part, part animation information of the part bone resource of the part based on whole-body animation information of the whole-body bone resource, the part animation information inheriting an animation behavior of the part in the whole-body animation information;
an appearance resource loading module, configured to load an appearance resource of the part based on appearance resource indication information of the part, the appearance resource indication information indicating the appearance resource of the part; and
a control module, configured to conceal the whole-body bone resource, and control, based on the part animation information, the appearance resource to perform an animation behavior following the part bone resource.

In some embodiments, the bone resource loading module is configured to:
create a parent bone component, and import the whole-body bone resource into the parent bone component; and
mount, for each part, a child bone component of the part on the parent bone component, and import the part bone resource of the part into the child bone component.

In some embodiments, the configuration module is configured to:
create a whole-body animation state machine, and mount the whole-body animation state machine on the parent bone component, the whole-body animation state machine being configured to control an animation behavior of the virtual object;
create a part animation state machine of the part, and mount the part animation state machine on the child bone component, the part animation state machine being configured to control an animation behavior of the part of the virtual object; and
pass the whole-body animation information carried by the whole-body animation state machine to the part animation state machine, to generate the part animation information.

In some embodiments, the control module is configured to:
bind, for each part, an appearance resource of the part to a child bone component of the part;
determine rendering pose information of the appearance resource in a current picture frame based on part animation information mounted by the child bone component; and
render an appearance resource of the part in the current picture frame based on the rendering pose information of each part, appearance resources of the plurality of parts being assembled to form an animation behavior of the virtual object in the current picture frame.

In some embodiments, the control module is further configured to:
conceal rendering pose information of the parent bone component, the rendering pose information of the parent bone component being determined based on the whole-body animation information.

In some embodiments, the apparatus further includes:
a division module, configured to divide the virtual object into the plurality of parts based on division manner indication information; and
a creation module, configured to create, for each part, at least one appearance resource adapted to the part.

In some embodiments, the bone resource loading module is configured to:
determine, based on a species type of the virtual object, an initial bone resource of the species type; and
configure the initial bone resource based on a posture parameter of the virtual object, to obtain the whole-body bone resource.

In some embodiments, the appearance resource loading module is configured to:
determine a resource address of the appearance resource based on the appearance resource indication information; and
access the resource address, and load the appearance resource stored in the resource address.

In some embodiments, the appearance resource loading module is further configured to:
determine, from a plurality of parts of the virtual object by the electronic device in a current picture frame, an item changing part having a change in appearance with respect to a previous picture frame; and
load an item changing appearance resource of the item changing part based on item changing resource indication information of the item changing part, the item changing resource indication information indicating an appearance resource of the item changing part after the item changing.

In another one aspect, an electronic device is provided, including one or more processors and one or more memories, the one or more memories having at least one computer program stored therein, the at least one computer program being loaded and executed by the one or more processors to implement the virtual object control method according to any one of the foregoing possible implementations.

In another one aspect, a non-transitory computer-readable storage medium is provided, having at least one computer program stored therein, the at least one computer program being loaded and executed by a processor to implement the virtual object control method according to any one of the foregoing possible implementations.

In another one aspect, a computer program product is provided, including one or more computer programs, the one or more computer programs being stored in a computer-readable storage medium. One or more processors of an electronic device can read the one or more computer programs from the computer-readable storage medium, the one or more processors executing the one or more computer programs, so that the electronic device can perform the virtual object control method according to any one of the foregoing possible implementations.

The virtual object is split into a plurality of parts, a part bone resource is loaded for each part, and the part is independently controlled by using part animation information to perform an animation behavior. However, the part animation information inherits whole-body animation information, so that the animation behavior of each part is kept consistent with an animation behavior of a whole body. An appearance resource is loaded in units of parts. Pose adaptation is performed on the appearance resource by using the part animation information, so that the appearance resources of the parts are assembled to form an appearance resource of a whole body of the virtual object. In this way, each picture frame in a real-time picture stream only needs to load an appearance resource having a change in appearance as required, thereby optimizing a resource loading logic of each picture frame, reducing a loading burden of a terminal, improving loading efficiency of the virtual object, shortening time consumed for rendering the virtual object, and reducing a probability of stuttering.

### BRIEF DESCRIPTION OF THE DRAWINGS

To describe embodiments of the present disclosure, the following briefly describes the accompanying drawings used for describing the embodiments. The accompanying drawings in the following description show merely some embodiments of the present disclosure, and a person of ordinary skill in the art can still derive other accompanying drawings from these accompanying drawings without creative efforts.

FIG. 1 is a schematic diagram of an implementation environment of a virtual object control method according to an embodiment of the present disclosure.

FIG. 2 is a flowchart of a virtual object control method according to an embodiment of the present disclosure.

FIG. 3 is a flowchart of a virtual object control method according to an embodiment of the present disclosure.

FIG. 4 is a schematic diagram of a bone component configuration interface according to an embodiment of the present disclosure.

FIG. 5 is a schematic diagram of a parent bone component according to an embodiment of the present disclosure.

FIG. 6 is an interaction diagram of creating a whole-body animation state machine according to an embodiment of the present disclosure.

FIG. 7 is a schematic diagram showing division of parts of a virtual object according to an embodiment of the present disclosure.

FIG. 8 is a schematic diagram of a part animation state machine according to an embodiment of the present disclosure.

FIG. 9 is a schematic diagram of a game engine configuration interface according to an embodiment of the present disclosure.

FIG. 10 is a schematic diagram of a blueprint interface of a body animation state machine according to an embodiment of the present disclosure.

FIG. 11 is a schematic diagram of an appearance resource management interface according to an embodiment of the present disclosure.

FIG. 12 is a schematic diagram of an avatar system assembly configuration interface according to an embodiment of the present disclosure.

FIG. 13 is a schematic diagram of another avatar system assembly configuration interface according to an embodiment of the present disclosure.

FIG. 14 is an effect diagram of assembly and rendering of parts of a virtual object according to an embodiment of the present disclosure.

FIG. 15 is a flowchart of a principle of a virtual object control method according to an embodiment of the present disclosure.

FIG. 16 is a frame diagram of an animation inheritance logic of a virtual object according to an embodiment of the present disclosure.

FIG. 17 is an architecture diagram of bone components of a virtual object according to an embodiment of the present disclosure.

FIG. 18 is a schematic structural diagram of a virtual object control apparatus according to an embodiment of the present disclosure.

FIG. 19 is a schematic structural diagram of an electronic device according to an embodiment of the present disclosure.

### DETAILED DESCRIPTION

The following further describes implementations of the present disclosure in detail with reference to the accompanying drawings.

In the present disclosure, terms such as “first” and “second” are configured for distinguishing between same or similar items with substantially same effects and functions. No logical or temporal dependency exists among “first”, “second”, and “n^{th}”, and a quantity and an execution order are not limited.

In the present disclosure, the term “at least one” means one or more, and “a plurality of” means two or more. For example, a plurality of first locations mean two or more first locations.

In the present disclosure, the term “including at least one of A or B” involves the following several cases: including only A, including only B, and including both A and B.

User-related information (including but not limited to device information, personal information, behavior information, and the like of a user), data (including but not limited to data for analysis, stored data, displayed data, and the like), and a signal involved in the present disclosure are all licensed, approved, authorized by the user, or fully authorized by all parties when a method in the embodiments of the present disclosure is applied to a specific product or technology, and collection, use, and processing of the related information, the data, and the signal need to comply with relevant laws, regulations, and standards of relevant countries and regions. For example, a bone resource and an appearance resource of each part of a virtual object involved in the present disclosure are both obtained under full authorization.

Terms involved in the embodiments of the present disclosure are explained and described below.

Multiplayer online battle arena (MOBA) game: It is a game in which several strongholds are provided in a virtual scene, and users in different camps control virtual objects to fight in the virtual scene, occupy strongholds or destroy strongholds of an opponent camp. For example, users may be divided into at least two camps in an MOBA game, and different teams belonging to at least two camps occupy respective map regions and compete with a certain victory condition as a goal. The victory condition includes but is not limited to at least one of occupying a stronghold or destroying a stronghold of the opponent camp, defeating a virtual object of the opponent camp, achieving survival in a specified scene and specified time, snatching a certain resource, and getting a higher interaction score than an opponent in specified time. For example, users may be divided into two camps in an MOBA game, virtual objects controlled by the users are scattered in a virtual scene to compete with each other, and a victory condition is to destroy or occupy a target building/stronghold/base/crystal deep in an opponent region. In some embodiments, each team includes one or more virtual objects, such as 1, 2, 3, or 5 virtual objects. Based on a quantity of virtual objects in each team participating in a game, a tactical competition may be divided into a 1V1 competition, a 2V2 competition, a 3V3 competition, a 5V5 competition, and the like. 1V1 refers to “1 versus 1”. In some embodiments, the MOBA game is played in units of battles (or rounds), and scene maps selected in each battle may be the same or different. A duration of each round of the MOBA game is from a moment the game starts to a moment any team or camp achieves the victory condition.

Virtual scene: It is a virtual environment displayed (or provided) when an application runs on a terminal. The virtual scene may be a simulation environment for the real world, or may be a semi-simulation and semi-fiction virtual environment, and may also be a purely fictional virtual environment. The virtual scene may be any one of a two-dimensional virtual scene, a 2.5-dimensional virtual scene, or a three-dimensional virtual scene, and the dimensions of the virtual scene are not limited in the embodiments of the present disclosure. For example, the virtual scene may include sky, land, ocean, and the like. The land may include environmental elements such as desert and city, and a user may control a virtual object to move in the virtual scene. In some embodiments, the virtual scene may be further configured for a virtual scene fight between at least two virtual objects, and there are virtual resources available for use by the at least two virtual objects in the virtual scene.

Virtual object: It is a movable object in a virtual scene. The movable objects may be a virtual person, a virtual animal, a cartoon character, and the like, for example, characters, animals, plants, oil drums, walls, or stones displayed in the virtual scene. The virtual object may be a virtual image for representing a user in the virtual scene. The virtual scene may include a plurality of virtual objects, and each virtual object has a shape and a volume in the virtual scene, and occupies some space in the virtual scene. In some embodiments, when the virtual scene is a three-dimensional virtual scene, the virtual object may be a three-dimensional stereoscopic model. The three-dimensional stereoscopic model may be a three-dimensional character constructed based on a three-dimensional human bone technology. A same virtual object may show different external images by wearing different skins. In some embodiments, the virtual object may also be implemented by using a 2.5-dimensional model or 2-dimensional model, which is not limited in the embodiments of the present disclosure.

In some embodiments, the virtual object may be a player character controlled through an operation on a client, may further be a non-player character (NPC) that is set and can interact in a virtual scene, a neutral virtual object (for example, a wild monster that provides resources such as a buff and an experience point), may further be a game robot (such as a companion robot) set in a virtual scene. Schematically, the virtual object is a virtual character competing in a virtual scene. In some embodiments, a quantity of virtual objects participating in interaction in the virtual scene may be preset, or may be dynamically determined based on the quantity of clients participating in the interaction.

Part (BodyPart): A virtual object can be split into a plurality of parts of the virtual object based on preset division manner indication information. For example, a virtual object is split into the following parts: a body, a head, a hair style, limbs, and the like.

Game engine: It refers to a core component of some written editable computer game systems or some interactive real-time image applications. These systems provide game designers with various tools required for writing a game, so that the game designer can easily and quickly make a game program without starting from scratch. The game engine includes the following systems: an animation engine, a rendering engine, a physical engine, a collision detection system, a sound effect, a script engine, artificial intelligence, a network engine, and scene management.

Unreal Engine (UE): It is an industry-leading game engine developed by a game company EPIC, and is a complete game development platform for a next-generation game console and a DirectX 9 personal computer, which provides a large number of core technologies, data generation tools, and basic support required by a game developer.

Animation: It records a state of an object at a certain moment in a manner of a time frame, and then performs switching based on a sequence and a time interval. Animation principles of all software are similar. In the Unity engine, a behavior (also referred to as an animation behavior) of each virtual object is controlled by an animation state machine of the engine.

Animation state machine (Animator Controller): It is a manager configured to manage a plurality of animation playback states in the Unity engine, and is a state machine that can manage an action change of a virtual object in a virtual scene and control generation of an action animation of the virtual object. In an animation engine, the animation state machine connects upward to an animation logic layer, and controls an animation pipeline downward.

The animation state machine allows a user to manage an animation sequence and a triggering condition of a virtual object by customizing an animation node of the animation state machine, to implement a complex animation or interaction effect. In the animation state machine, each animation state in which the virtual object is located indicates an animation behavior. For example, an animation state includes a standing state, a fighting state, or an elimination state, and a corresponding animation behavior includes a standing behavior, a fighting behavior, or a falling behavior. For example, in a process of generating an animation of a behavior, an animation node corresponding to the behavior is created on an animation state machine in an animation engine, and different animation nodes need to be created for different behaviors on the animation state machine.

Rendering engine: In the field of image technologies, a rendering engine refers to rendering a three-dimensional model modeled for a virtual object into a two-dimensional image, so that a stereoscopic effect of the three-dimensional model is still maintained in the two-dimensional image. Particularly, in the field of game technologies, for a virtual scene arranged in a game and all virtual objects in the virtual scene, after model data of a modeled three-dimensional model is imported into a rendering engine, a rendering pipeline in a graphics processing unit (GPU) is driven through the rendering engine to perform rendering, thereby visually presenting an object indicated by the three-dimensional model on a display screen of a terminal.

GPU: It is a specialized chip used in a modern personal computer, a server, a mobile device, a game console, or the like specially for graphics and image processing.

Graphics application programming interface (API): A process of a central processing unit (CPU) performing communication with a GPU is performed based on a graphics API of a specific standard. Mainstream graphics APIs include OpenGL, OpenGL ES, Direct X, Metal, Vulkan, and the like. A GPU manufacturer implements interfaces of some specifications during production of GPUs. During graphics development, a GPU can be invoked based on a method defined by the interface.

Rendering pipeline: It is a graphics rendering process running in a GPU. An image rendering process usually involves the following a few rendering pipelines: a vertex shader, a rasterizer, and a pixel shader. By writing code in a shader, a GPU can be controlled to draw and render a rendering component.

Game thread (GameThread): It is one of threads when a multi-threading technology is used during running of a game application, which is configured to maintain a main game business logic, and may be configured to implement a creation/destruction logic of a virtual item, a virtual object, or the like.

Render thread (RenderThread): It is one of threads when a multi-threading technology is used during running of a game application, which is configured for a rendering instruction processing logic at a non-hardware level.

Avatar system: The Avatar system is a system used in a game to increase a quantity of character appearances by subdividing and recombining character models or images.

The concept of the embodiments of the present disclosure is briefly described below.

In a game picture rendering scene, during running of a game application, each frame of a game picture needs to be rendered in real time. A motion performed by a virtual object in each picture frame is referred to as an animation behavior. At each moment, rendering pose information of the virtual object can be determined based on the animation behavior of the virtual object, and then a multimedia resource of the virtual object is rendered by using the rendering pose information, so that the virtual object can be displayed in a virtual scene, thereby realizing visualization presentation of the virtual object and an appearance thereof.

The virtual object may show different external images by wearing different skins. However, in some game applications having a relatively high degree of freedom for appearance application, a user may be free to select a face shape, a head shape, and the like, to implement face pinching on the virtual object. Alternatively, the user may further be free to apply an appearance such as a coat, pants, a shoe, a headdress, a facial ornament, a waist ornament, an earring, a back ornament, a necklace, a bracelet, and a glove, to achieve item changing of the virtual object. Alternatively, the user may further be free to apply a prop appearance, a prop ornament, or the like possessed by the virtual object, to decorate a virtual prop. Alternatively, the user may further equip the virtual object with a tail, purchase a special skill effect, or the like. Therefore, with product iteration of the game application, appearance performance requirements of the user for the virtual object continuously increase.

The game application needs to load appearance resources of all virtual objects within a field of view in each picture frame, and control the appearance resource of each virtual object to change with a bone pose of the virtual object. In this way, with an increase in appearance performance requirements, appearance resources are to become increasingly abundant. If the game application loads complex appearance resources in each frame, appearance resources of a large number of virtual objects may have a problem of bloated reference relationships, and the game application has low loading efficiency and long rendering time for the virtual object, and is prone to stuttering.

In view of this, the embodiments of the present disclosure provide a virtual object control method, through which parts of a virtual object can be split and then dynamically assembled, to ensure that a configuration scheme of dynamically loading and unloading an appearance resource supporting flexible item changing is formed without affecting a rendering effect. During real-time rendering, each virtual object is dynamically assembled by a plurality of parts. In this way, if a user only changes appearance resources of some certain parts (for example, changes a headdress or a waist ornament), during streaming resource loading, the user does not need to reload an appearance resource of a whole body of the virtual object once again, but only needs to load appearance resources of the changed parts, so that each part of the virtual object can be individually replaced based on a user requirement, thereby fully satisfying requirements for appearance performance of the virtual object in different details, reducing a loading burden and performance overhead on a terminal side, improving the loading efficiency of the virtual object, shortening the time consumed for rendering the virtual object, and reducing the probability of stuttering. A detailed description is to be provided subsequently through the following a few embodiments.

A system architecture involved in the present disclosure is described below.

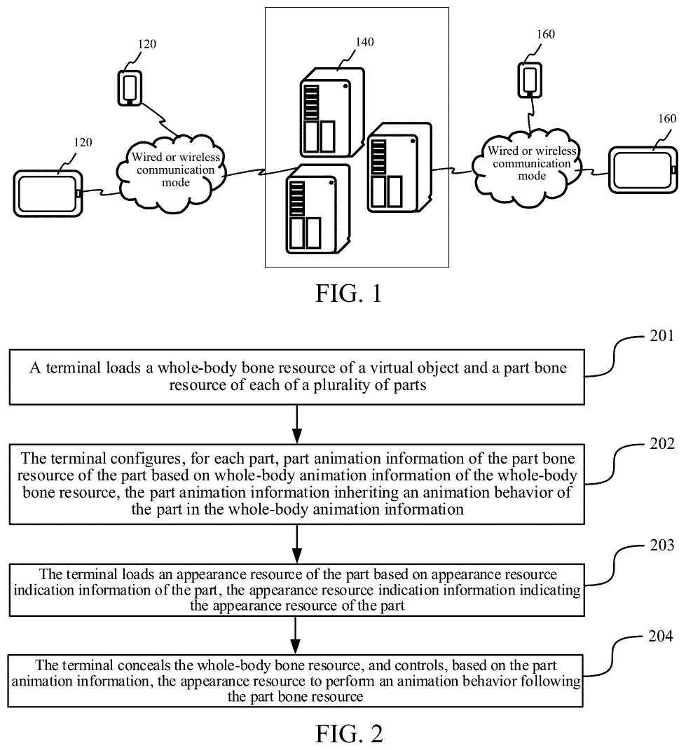

FIG. 1 is a schematic diagram of an implementation environment of a virtual object control method according to an embodiment of the present disclosure. Referring to FIG. 1, the implementation environment includes a first terminal 120, a server 140, and a second terminal 160.

An application supporting a virtual scene is installed and run in the first terminal 120. The application includes any one of an MOBA game, a first-person shooting game, a third-person shooting game, a virtual reality application, a three-dimensional map program, or a multiplayer survival game involving equipment. In some embodiments, the first terminal 120 is a terminal used by a first user. The first terminal 120 runs the application. A user interface of the application is displayed on a screen of the first terminal 120, and a virtual scene is loaded and displayed in the application based on a game start operation of the first user on the user interface. The first user uses the first terminal 120 to operate a first virtual object in the virtual scene to perform an animation behavior. The animation behavior includes, but is not limited to: at least one of adjusting a body posture, crawling, walking, running, riding, jumping, driving, pickup, shooting, attacking, throwing, and confronting. Exemplarily, the first virtual object is a first virtual character, for example, a simulated character or a cartoon character.

The first terminal 120 and the second terminal 160 are in direct or indirect communication connection with the server 140 through wired or wireless communication.

The server 140 includes at least one of a server, a plurality of servers, a cloud computing platform, or a virtualization center. The server 140 is configured to provide a background service for an application supporting the virtual scene. In some embodiments, the server 140 is in charge of primary computing, and the first terminal 120 and the second terminal 160 are in charge of secondary computing. Alternatively, the server 140 is in charge of secondary computing, and the first terminal 120 and the second terminal 160 are in charge of primary computing. Alternatively, the server 140, the first terminal 120, and the second terminal 160 perform collaborative computing by using a distributed computing architecture.

In some embodiments, the server 140 is an independent physical server, or is a server cluster formed by a plurality of physical servers or a distributed system, or is a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform.

An application supporting a virtual scene is installed and run in the second terminal 160. The application includes any one of an MOBA game, a first-person shooting game, a third-person shooting game, a virtual reality application, a three-dimensional map program, or a multiplayer survival game involving equipment. In some embodiments, the second terminal 160 is a terminal used by a second user. The second terminal 160 runs the application. A user interface of the application is displayed on a screen of the second terminal 160, and a virtual scene is loaded and displayed in the application based on a game start operation of the second user on the user interface. The second user uses the second terminal 160 to operate a second virtual object in the virtual scene to perform an animation behavior. The animation behavior includes, but is not limited to: at least one of adjusting a body posture, crawling, walking, running, riding, jumping, driving, pickup, shooting, attacking, throwing, and confronting. Exemplarily, the second virtual object is a second virtual character, for example, a simulated character or a cartoon character.

In some embodiments, the first virtual object controlled by the first terminal 120 and the second virtual object controlled by the second terminal 160 are located in a same virtual scene. In this case, the first virtual object can interact with the second virtual object in the virtual scene.

Schematically, the first virtual object and the second virtual object above have a hostile relationship. For example, the first virtual object and the second virtual object belong to different camps or teams. Virtual objects in a hostile relationship can interact through fighting on land, such as firing a shooting prop to each other, or throwing a throwing prop. In some other embodiments, the first virtual object and the second virtual object have a teammate relationship. For example, the first virtual object and the second virtual object belong to a same camp or a same team, and have a friend relationship or have a temporary communication permission.

In some embodiments, the applications installed on the first terminal 120 and the second terminal 160 are the same, or the applications installed on the two terminals are the same type of applications on different operating system platforms. The first terminal 120 and the second terminal 160 both generally refer to one of a plurality of terminals. In the embodiments of the present disclosure, only the first terminal 120 and the second terminal 160 are used as an example for description.

The first terminal 120 and the second terminal 160 are of the same device type or different device types. The device type includes at least one of a smartphone, a tablet computer, a smart speaker, a smart watch, a smart handheld game console, a portable game device, an on-board terminal, a laptop portable computer, and a desktop computer, which is not limited thereto. For example, the first terminal 120 and the second terminal 160 are both smartphones or other portable game devices.

A person skilled in the art can learn that a quantity of the foregoing terminals is larger or smaller. For example, only one terminal, or dozens or hundreds of terminals, or a larger quantity of terminals may be provided. A quantity of terminals and the device type are not limited in the embodiments of the present disclosure.

A basic process of the virtual object control method provided in the embodiments of the present disclosure is described below.

FIG. 2 is a flowchart of a virtual object control method according to an embodiment of the present disclosure. Referring to FIG. 2, the embodiment is performed by an electronic device. A description is provided by using an example in which the electronic device is a terminal. The embodiment includes the following operations:

201: A terminal loads a whole-body bone resource of a virtual object and a part bone resource of each of a plurality of parts.

In some embodiments, a user starts a game application on a terminal, and loads and displays a virtual scene in the game application. Since the virtual scene includes one or more virtual objects and environmental elements, for any virtual object in the virtual scene, an animation behavior of the virtual object at any moment can be controlled by using the method provided in the embodiments of the present disclosure, so as to display the virtual object performing the animation behavior in the virtual scene.

In some embodiments, for a current picture frame in a game picture stream, the current picture frame refers to a picture frame displayed on a screen at a current moment. The terminal needs to confirm that a technical person has divided a virtual object into a few parts in advance, then load a whole-body bone resource of the virtual object, and load a part bone resource of each part. The part bone resources of all parts are assembled to form the whole-body bone resource. In this way, the bone resources of the virtual object can be prevented from being omitted, and an error in a rendering effect can be avoided.

The bone resource involved in the embodiments of the present disclosure refers to point cloud data of an object model of the virtual object, the whole-body bone resource refers to point cloud data of an entire object model of the virtual object, and the part bone resource refers to point cloud data of a part separated from the whole-body bone resource. The technical person may predefine a quantity of parts into which the virtual object is to be split and a location of each part in the object model of the virtual object, which is not limited in the embodiments of the present disclosure.

In addition to a game application, the embodiments of the present disclosure may further be applied to another application where a virtual object needs to be displayed. For example, a virtual object corresponding to an account is displayed in a chat application, or a virtual object is displayed in a live streaming picture in a live streaming application. A processing process in another application is the same as the processing process in the game application, which is not described again in the embodiments of the present disclosure.

202: The terminal configures, for each part, part animation information of the part bone resource of the part based on whole-body animation information of the whole-body bone resource, the part animation information inheriting an animation behavior of the part in the whole-body animation information.

The whole-body animation information is configured for indicating an animation behavior performed by a whole body of the virtual object in the current picture frame.

The part animation information is configured for indicating an animation behavior performed by a certain part of the virtual object in the current picture frame. The part animation information indicates that the animation behavior of the part inherits the animation behavior of the whole body indicated in the whole-body animation information.

In some embodiments, the animation behavior includes, but is not limited to a standing behavior, a fighting behavior, a sprinting behavior, a falling behavior, and the like. A type of the animation behavior is not specifically limited in the embodiments of the present disclosure.

In some embodiments, regardless of the whole-body animation information or the part animation information, the foregoing animation information may be implemented as an animation node in an animation state machine of an animation engine. The animation node characterizes an animation state in the animation state machine. The animation state essentially indicates an animation behavior performed by the whole body or a certain part of the virtual object in the current picture frame.

In some embodiments, for each part separated from the virtual object, the part animation information of the part bone resource of the part can be configured based on the whole-body animation information of the whole-body bone resource. For example, an animation state recorded in the animation node by the whole-body animation information is directly assigned to the animation node created in the part animation information. In this way, it can be ensured that the part animation information may inherit the whole-body animation information, thereby preventing the animation behavior of each part separated from the virtual object from being inconsistent with an animation behavior of a whole body, and indirectly ensuring that a rendering effect of the plurality of parts after being combined is consistent with a global whole rendering effect after the virtual object is split into the plurality of parts.

203: The terminal loads an appearance resource of the part based on appearance resource indication information of the part, the appearance resource indication information indicating the appearance resource of the part.

In some embodiments, since the virtual object has been divided into a plurality of parts, when appearance resources of the virtual object are stored, the appearance resource (such as skin) of the whole body is not stored in units of virtual objects, but the appearance resource of each part is stored in units of parts of the virtual object, and the appearance resource is indicated through the appearance resource indication information. In this way, a management manner and a storage manner of the appearance resource are greatly optimized.

In some embodiments, in the current picture frame, the terminal determines to-be-loaded appearance resource indication information. For example, the to-be-loaded appearance resource indication information includes only item changing resource indication information of an item changing part having a change in appearance with respect to a previous picture frame. In this way, for a part having no change in appearance, a new appearance resource does not need to be repeatedly loaded, and only a new appearance resource after the item changing needs to be loaded for the item changing part having a change in appearance, so that a resource loading logic of each picture frame in the real-time picture stream is optimized, thereby reducing the loading burden of the terminal, improving the loading efficiency of the virtual object, shortening the time consumed for rendering the virtual object, and reducing the probability of stuttering.

In some embodiments, the appearance resource indication information of each part is provided as a resource identifier (ID) of a corresponding appearance resource. The terminal may read, based on one or more to-be-loaded resource IDs, an appearance resource indicated by each resource ID from a cache, or apply, by using one or more to-be-loaded resource IDs, to a server for the appearance resource indicated by each resource ID. A loading manner of the appearance resource is not specifically limited in the embodiments of the present disclosure.

In some other embodiments, the appearance resource indication information of each part is provided as a resource address of a corresponding appearance resource. The terminal accesses one or more to-be-loaded resource addresses, and may download an appearance resource stored in each resource address. A type of the appearance resource indication information is not specifically limited in the embodiments of the present disclosure.

In an example, 10 wearable styles are provided for a part “waist ornament”, then 10 appearance resources corresponding to the 10 styles are to be stored, and 10 different resource IDs are assigned to the 10 appearance resources. In this way, when a user controls a virtual object to wear a waist ornament of a specified style A, the user does not need to load an appearance resource of a whole-body of the virtual object wearing the waist ornament of the style A, but keeps appearance resources of other parts of the virtual object unchanged, and only uses the resource ID of the waist ornament of the style A to additionally load an appearance resource specific to the style A of the part “waist ornament”, which saves overheads of loading appearance resources of other parts.

204: The terminal conceals the whole-body bone resource, and controls, based on the part animation information, the appearance resource to perform an animation behavior following the part bone resource.

In some embodiments, in a process of drawing, by the terminal in a virtual scene, the virtual object performing the animation behavior, the whole-body bone resource is essentially to provide a piece of whole-body animation information, so as to control part animation information of each part bone resource (because the part animation information inherits the whole-body animation information). However, the whole-body bone resource does not need to load or bind any appearance resource, and therefore the whole-body bone resource is directly concealed. In this way, performance overheads for rendering the whole-body bone resource may be saved, and ghosting from rendering the virtual object in the current picture frame may also be avoided, thereby ensuring a good rendering effect.

In some embodiments, after the whole-body bone resource is concealed, for each separated part, through use of the part animation information of the part, the appearance resource of the part is controlled to perform a corresponding animation behavior following the part bone resource of the part, so as to prevent the appearance resource from not performing an action following the bone resource, and ensure that the appearance resource of each part can adapt to the animation behavior of the part to change a pose. For example, when a whole body of the virtual object performs an animation behavior “sprinting”, an animation behavior of a part “headdress” inherits the animation behavior “sprinting” of the whole body. Then in the process of operation 204, an appearance resource (i.e., a headdress resource of a specified style) of the part “headdress” needs to be controlled to present a pose change (for example, a hair ornament sways based on a sprinting direction) under the behavior of “sprinting”.

In some embodiments, for each separated part, pose adaptation is performed on the animation behavior by controlling the appearance resource in the foregoing manner, and the appearance resource of each part after the pose adaptation is rendered, so that the appearance resources of all parts are assembled to form an appearance resource of the whole body of the virtual object. In addition, the appearance resource of the whole body performs a whole, global, and consistent animation behavior, and no behavior separation occurs between different parts of the virtual object, thereby ensuring smooth and natural transition and switching of animation behaviors.

The virtual object control method involved in the embodiments of the present disclosure may be applicable to controlling of an animation behavior of any virtual object in a virtual scene at any moment, so that the virtual object performing the animation behavior is displayed in a picture. Therefore, this solution can be applied to any picture frame in a picture stream to control animation behaviors of all virtual objects and display character appearances, and has a wide range of applicable scenes.

Any combination of all of the foregoing optional solutions can be used to obtain an optional embodiment of the present disclosure, and the details are not described herein again.

According to the method provided in the embodiments of the present disclosure, the virtual object is split into a plurality of parts, a part bone resource is loaded for each part, and the part is independently controlled by using part animation information to perform an animation behavior. However, the part animation information inherits whole-body animation information, so that the animation behavior of each part is kept consistent with the animation behavior of the whole body. An appearance resource is loaded in units of parts. Pose adaptation is performed on the appearance resource by using the part animation information, so that the appearance resources of the parts are assembled to form an appearance resource of a whole-body of the virtual object. In this way, each picture frame in a real-time picture stream only needs to load an appearance resource having a change in appearance as required, thereby optimizing a resource loading logic of each picture frame, reducing a loading burden of a terminal, improving loading efficiency of the virtual object, shortening time consumed for rendering the virtual object, and reducing a probability of stuttering.

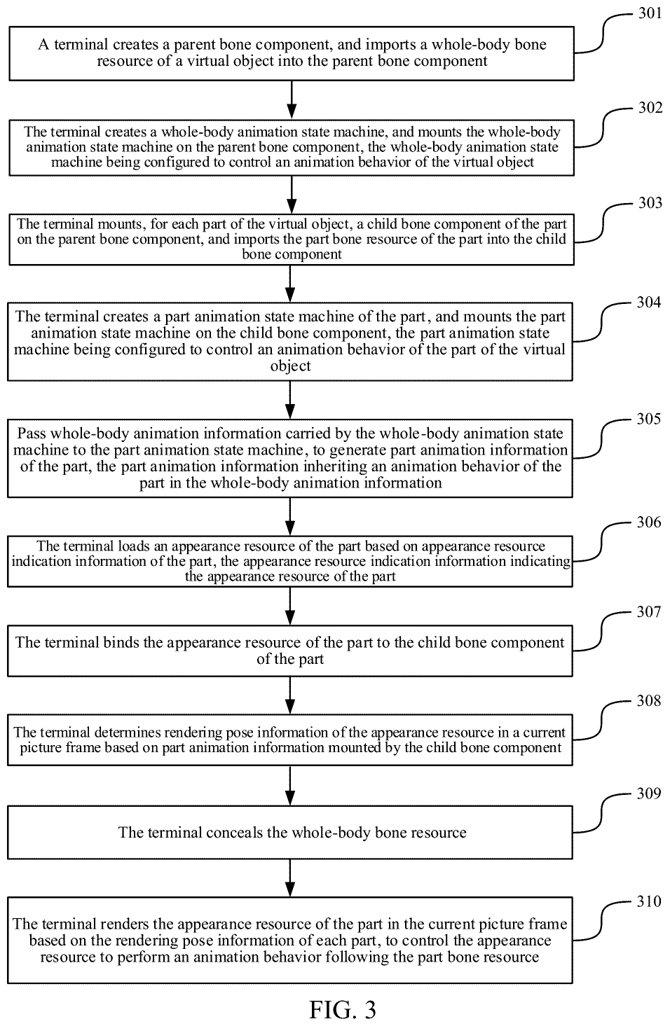

In the foregoing embodiment, the basic process of the virtual object control method is briefly described. However, in this embodiment of the present disclosure, a detailed process of the virtual object control method is to be exemplarily described. FIG. 3 is a flowchart of a virtual object control method according to an embodiment of the present disclosure. The embodiment is performed by an electronic device. A description is provided by using an example in which the electronic device is a terminal. The embodiment includes the following operations.

301: The terminal creates a parent bone component, and imports a whole-body bone resource of the virtual object into the parent bone component.

In some embodiments, a user starts a game application on a terminal, and creates a game thread GameThread and a render thread RenderThread for the game application, the game thread GameThread being configured to maintain a main game business logic, and the render thread RenderThread being configured for a rendering instruction processing logic at a non-hardware level. The game thread GameThread reads a scene resource of a virtual scene from a cache, or pulls the scene resource of the virtual scene from a server. Next, the game thread GameThread submits the scene resource of the virtual scene to the render thread RenderThread, thereby loading and displaying the virtual scene in the game application.

Since the virtual scene includes one or more virtual objects and environmental elements, for any virtual object in the virtual scene, an animation behavior of the virtual object at any moment can be controlled by using the method provided in the embodiments of the present disclosure, so as to display the virtual object performing the animation behavior in the virtual scene. For a current picture frame in a game picture stream, the current picture frame refers to a picture frame displayed on a screen at a current moment. The terminal may first load the whole-body bone resource of the virtual object, then create a parent bone component in a game engine, and import the whole-body bone resource into the parent bone component. The whole-body bone resource refers to point cloud data of an entire object model of the virtual object, and the parent bone component refers to a piece of mesh data generated based on the whole-body bone resource. The mesh data may be considered as skin data, which is configured to characterize epidermis data of the entire object model of the virtual object.

In some embodiments, in a process of loading the whole-body bone resource, the terminal may determine, based on a species type of the virtual object, an initial bone resource of the species type, and configure the initial bone resource based on a posture parameter of the virtual object, to obtain the whole-body bone resource. For example, for each virtual object in the current picture frame, the game thread GameThread of the game application on the terminal determines the species type and the posture parameter of the virtual object, then accesses the initial bone resource of the species type, and fine-tunes the initial bone resource by using the posture parameter, to obtain a whole-body bone resource.

The species type indicates a virtual species to which the virtual object belongs. For example, the species type includes a human, a beast, or a pet. The species type may be provided as a species ID. The posture parameter indicates a posture possessed by a virtual object. For example, the posture parameter includes gender, tall, short, fat, thin, and a limb length. The species type and the posture parameter are not specifically limited in the embodiments of the present disclosure.

In the foregoing process, different initial bone resources are configured for virtual objects of different species types, and the virtual objects of the same species type reuse the same initial bone resource. In this way, one whole-body bone resource does not need to be configured for each virtual object, but only each species type needs to be configured with one initial bone resource, and then each virtual object is configured with posture parameters thereof. In this way, a storage logic and a configuration logic of the bone resource can be optimized, storage overheads of a terminal side can be saved, and the loading burden of a game application can be reduced.

In some other embodiments, a whole-body bone resource may also be configured for each virtual object. In this way, the whole-body bone resource can be loaded only based on an object ID of the virtual object, thereby simplifying the loading process of the whole-body bone resource.

In some embodiments, virtual objects of the same species type may also be divided into a plurality of character sets in advance, to reuse the initial bone resource in units of character sets. In this way, the initial bone resource needs to be found based on a species ID and a character set ID during loading, a division logic of the character sets is defined, for example, ensuring that virtual objects having a small difference in body shapes are divided into the same character set, and an initial bone resource is designed for a virtual object having a typical body shape in the same species type. Each typical body shape corresponds to a character set. Virtual objects having a similar body shape are assigned to a corresponding character set to achieve reuse of the initial bone resource, so that the initial bone resource is more targeted to the body shape of a virtual object, thereby improving a degree of adaptation between the initial bone resource and the body shape of the virtual object.

In some embodiments, after the whole-body bone resource is loaded, a parent bone component is created in a game engine, and the whole-body bone resource is imported into the parent bone component, so that skin data of a virtual object that has not yet presented an appearance style (skin, exterior decoration, an ornament, or the like) can be previewed.

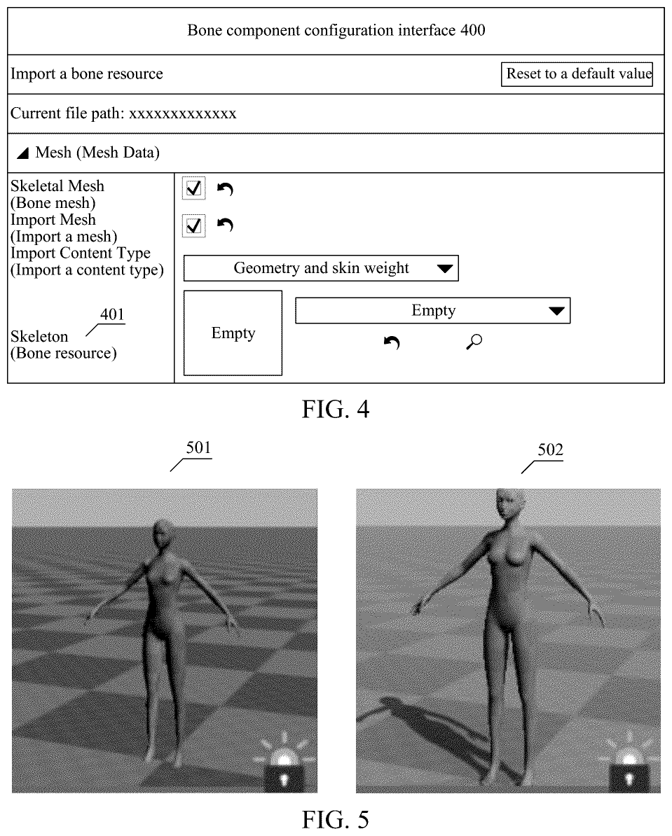

FIG. 4 shows a manner of importing a whole-body bone resource into a parent bone component. In a bone component configuration interface 400, a user may select, in a bone resource (Skeleton) option 401, a whole-body bone resource to be imported into the parent bone component, so as to generate a model file in an FBX format for the virtual object after the importing is completed, FBX being a file type.

FIG. 5 shows a parent bone component of a virtual object. It may be seen that a parent bone component 501 and a rotation view 502 of the parent bone component can convert a whole-body bone resource from original low-level point cloud data to mesh data that can be visually presented.

In the foregoing operation 301, a possible implementation where a terminal loads a whole-body bone resource of a virtual object is provided. The whole-body bone resource is imported into the parent bone component, so that it is convenient to use the parent bone component to record an animation behavior of a whole body of the virtual object, thereby avoiding tedious calculation of setting animation behaviors for different child bone components. Only each child bone component needs to inherit the animation behavior of the parent bone component, thereby ensuring consistency of the animation behaviors of different parts of the virtual object. In another embodiment, another possible implementation may further be adopted to load the whole-body bone resource of the virtual object.

In addition to a game application, the embodiments of the present disclosure may further be applied to another application where a virtual object needs to be displayed. For example, a virtual object corresponding to an account is displayed in a chat application, or a virtual object is displayed in a live streaming picture in a live streaming application. A processing process in another application is the same as the processing process in the game application, which is not described again in the embodiments of the present disclosure.

302: The terminal creates a whole-body animation state machine, and mounts the whole-body animation state machine on the parent bone component, the whole-body animation state machine being configured to control an animation behavior of the virtual object.

In some embodiments, the animation behavior of the virtual object is controlled by using the animation state machine in a game engine. After a whole-body bone resource is imported into a parent bone component, a whole-body animation state machine may be created for the parent bone component, so that the whole-body animation state machine is used as a carrier of whole-body animation information of the virtual object, to control the animation behavior of the whole body of the virtual object. In other words, the animation behavior of the whole body of the virtual object in each picture frame is entirely implemented in the whole-body animation state machine.

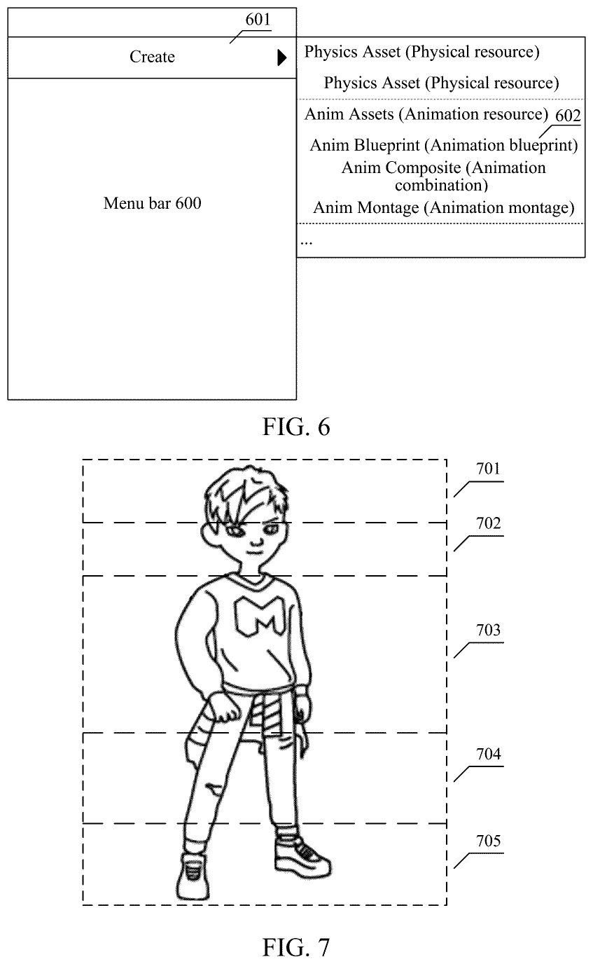

FIG. 6 shows an interaction mode of creating a whole-body animation state machine. A user can create a whole-body animation state machine by selecting an option 601 (Create) in a menu bar 600 of a game engine, and then selecting a blueprint (Anim Blueprint) option 602 of the animation state machine in an expanded submenu of the option 601 Create, and then mount the whole-body animation state machine on a parent bone component, to realize control and switching of basic animation behaviors of a whole body of a virtual object through the whole-body animation state machine.

303: For each part of the virtual object, a terminal mounts a child bone component of the part on the parent bone component, and imports the part bone resource of the part into the child bone component.

The parts of a virtual object include a part on the body of the virtual object or a part outside the body of the virtual object, for example, ornaments and clothes worn on the body of the virtual object, or the ground on which the virtual object stands.

In some embodiments, the technical person may predefine a quantity of parts into which the virtual object is to be split and a location of each part in an object model of the virtual object, generate a part bone resource of each part based on a whole-body bone resource, and associatively store the part bone resource of each part based on a part ID. In this way, for each part of the virtual object, a game thread GameThread of a game application on the terminal may first load the part bone resource of the part based on the part ID, then create a child bone component for each part in the game engine, the child bone component being mounted on the parent bone component created in operation 301, and then import the part bone resource of each part into the child bone component of the part. The foregoing operations are repeatedly performed until all parts of the virtual object are traversed. In this case, the part bone resources of all the parts can be loaded, and each part bone resource is imported into a corresponding child bone component.

The part bone resources of a plurality of parts of the virtual object are assembled to form a whole-body bone resource of the virtual object. In this way, the bone resources of the virtual object can be prevented from being omitted, and an error in a rendering effect can be avoided. The part bone resource refers to point cloud data of a specified part separated from the whole-body bone resource, and the child bone component refers to a piece of mesh data generated based on the part bone resource, which is configured for characterizing skin data of a specified part in the object model of the virtual object.

In some embodiments, in a stage of generating a part bone resource, a technical person may configure division manner indication information of the virtual object, then divide the virtual object into a plurality of parts based on the division manner indication information, and create a part bone resource adapted to the part for each of the parts.

FIG. 7 shows a division manner of parts of a virtual object. For example, the virtual object is divided into 5 parts: a head 701, a face 702, an upper body 703, a lower body 704, and feet 705. Such a clear and concise division manner does not require splitting and deployment of too many part bone resources, which reduces overheads of configuring the part bone resources.

Table 1 shows another division manner of parts of a virtual object. For example, the virtual object is divided into 6 categories of parts: conventional parts, handheld parts, parts outside the body, reserved parts, a special effect part, and special parts. Each category of parts is divided into parts with specific details. In this way, the virtual object can be finely divided, which facilitates subsequent loading of an appearance resource for each separated part, and the appearance resource of each part may be replaced independently, thereby implementing high-degree-of-freedom transformation of appearance display of the virtual object.

TABLE 1

| | |
|---|---|
| Conventional parts | Hair style |
| | Headdress (including hair style information and covering a current |
| | hair style) |
| | Facial ornament |
| | Body (including a glove) |
| | Pants |
| | Shoe |
| Handheld part | Prop transformation/handheld prop |
| | Prop ornament |
| Parts outside the body | Outside the body-in the air |
| | Outside the body-ground |
| Reserved parts | Waist/back (reserved parts of a prop and a prop accessory) |
| | Hip (a reserved part for a tail) |
| Special effect part | Special effect of a skill |
| Special parts | Ear/neck/wrist (retain appearance display) |

The foregoing FIG. 7 and Table 1 only provide two different division manners for the virtual object, and the technical person may configure a briefer or more detailed division manner based on different business requirements, which is not specifically limited in the embodiments of the present disclosure.

In some embodiments, different virtual objects may have the same or different division manners. For example, virtual objects reusing the same initial bone resource have the same division manner indication information, and virtual objects having different initial bone resources have different division manner indication information. Alternatively, virtual objects reusing the same initial bone resource also have different division manner indication information, which is not specifically limited in the embodiments of the present disclosure.

In the foregoing operation 303, a possible implementation of loading the part bone resource of each of a plurality of parts of the virtual object is provided. The part bone resource of each part is imported into a child bone component, so that after each child bone component inherits an animation behavior of a parent bone component, it can be ensured that animation behaviors of different child bone components of the same virtual object are consistent, thereby avoiding presentation of an uncoordinated display effect as a result of inconsistent animation behaviors of different parts. In another embodiment, another possible implementation may further be adopted to load the part bone resource of the part of the virtual object.

304: The terminal creates a part animation state machine of the part, and mounts the part animation state machine on the child bone component, the part animation state machine being configured to control an animation behavior of the part of the virtual object.

In some embodiments, for each part of a virtual object, a part animation state machine is created for a child bone component of the part, so that the part animation state machine is used as a carrier of part animation information of the part in the virtual object, to control an animation behavior of the part in the virtual object. To be specific, the animation behaviors of the part in the virtual object are all implemented in the part animation state machine, and finally the part animation state machine is mounted on the child bone component, to realize control and switching of the animation behaviors of the part of the virtual object through the part animation state machine. The foregoing operations are repeatedly performed until all parts of the virtual object are traversed. In this case, corresponding part animation state machines can be created for all the parts. The process of creating the part animation state machine is the same as the process of creating the whole-body animation state machine in operation 302, and details are not described herein again.

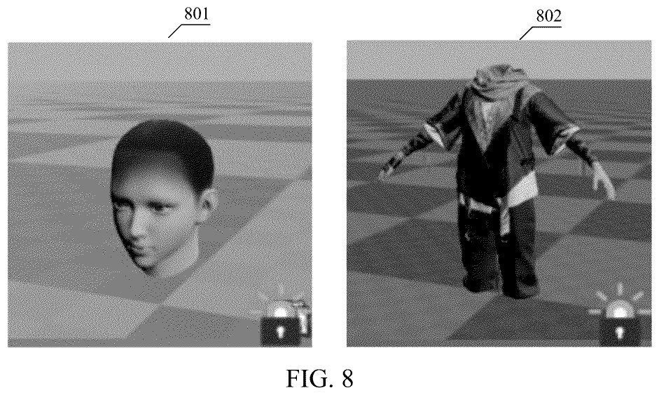

As shown in FIG. 8, a part “head” is used as an example, and a head animation state machine 801 that has been created is shown. The head animation state machine 801 carries head animation information (i.e., controlling an expression animation and head shaking of a virtual object). Similarly, a part “body” is used as an example, and a body animation state machine 802 that has been created is shown. The body animation state machine 802 carries body animation information (for example, animation information of clothes and fabrics).

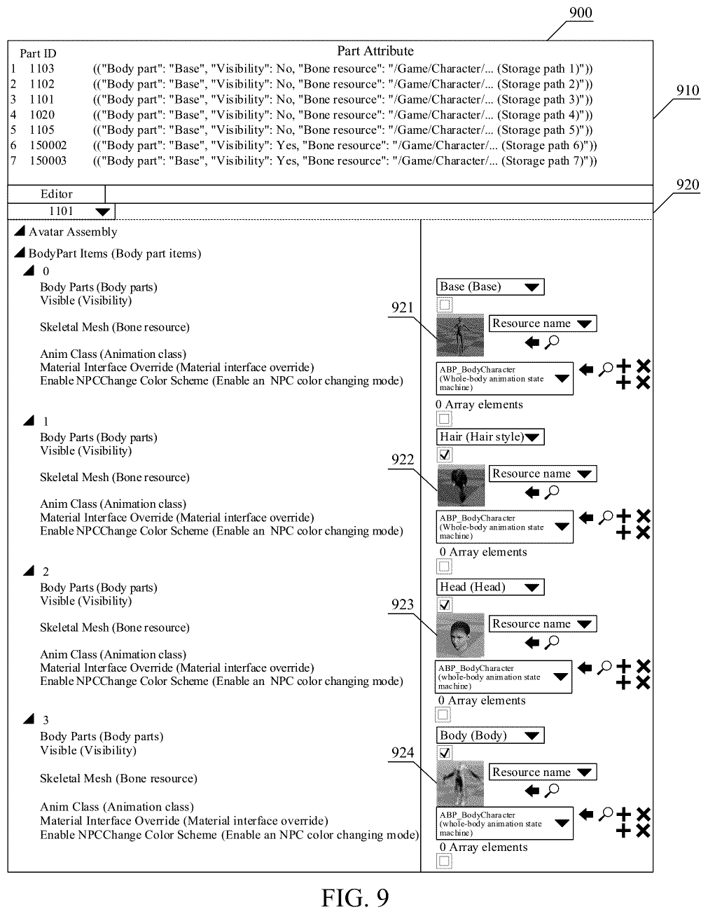

FIG. 9 is a schematic diagram showing an interface on which animation state machines of all parts of a virtual object are assembled. In a game engine configuration interface 900, a part table 910 in the upper half shows a part ID, a storage path of a part bone resource, and another attribute information of each of a plurality of parts of the virtual object. In a part assembly area 920 in the lower half, it may be seen that a component type of a parent bone component is base, and an imported whole-body bone resource 921 and a bound whole-body animation state machine ABP_BaseCharacter are displayed; a component type of a “hair style” child bone component is hair, and an imported hair style bone resource 922 and a bound hair style animation state machine ABP_HairCharacter are displayed; a component type of a “head” child bone component is head, and an imported head bone resource 923 and a bound head animation state machine ABP_FaceCharacter are displayed; and a component type of a “body” child bone component is body, and an imported body bone resource 924 and a bound body animation state machine ABP_BodyCharacter are displayed.

305: Pass whole-body animation information carried by the whole-body animation state machine to the part animation state machine, to generate part animation information of the part, the part animation information inheriting an animation behavior of the part in the whole-body animation information.

In some embodiments, for the part animation state machine of each part of a virtual object, the whole-body animation information carried in the whole-body animation state machine may be copied in real time, to generate the part animation information of the part. For example, a self-defined animation node is newly created in the part animation state machine, and the whole-body animation information of the whole-body animation state machine is copied to the animation node in real time, so as to calculate and generate local part animation information of the part through an underlying C++ function. The foregoing operations are repeatedly performed until all parts of the virtual object are traversed. In this case, respective part animation information can be generated for all parts.

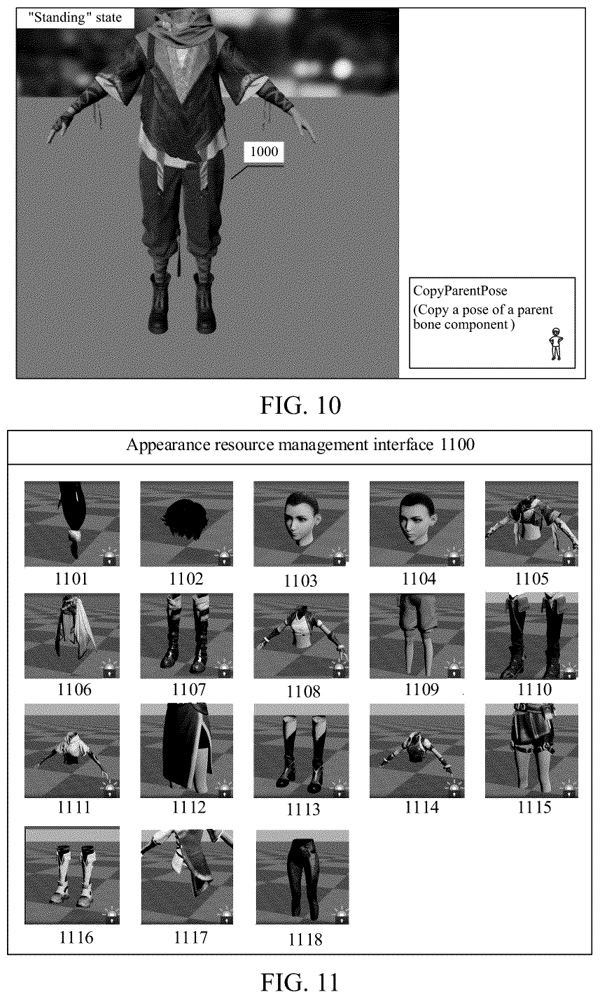

As shown in FIG. 10, assuming that in a certain picture frame, an animation behavior at a corresponding moment in a whole-body animation state machine is “standing”, for the part “body”, in a blueprint of the body animation state machine, an animation node is created at the moment, and the animation node is controlled to copy whole-body animation information “standing” recorded in the whole-body animation state machine. For example, inheritance of the animation node is implemented through “CopyParentPose” (copying a pose of a parent bone component). After body animation information of the body animation state machine is assigned “standing”, a body part 1000 of a virtual object presenting an animation behavior of “standing” is displayed in a left area.

In some embodiments, whole-body animation information of the virtual object at each moment in the whole-body animation state machine may be provided as an animation state ID recorded in the animation node at the moment. For example, an animation state ID of 01 represents “standing”, an animation state ID of 02 represents “fighting”, an animation state ID of 03 represents “sprinting”, and an animation state ID of 04 represents “falling”. Therefore, in a newly created animation node, each part animation state machine actually records an animation state ID (i.e., part animation information) copied from the whole-body animation state machine, but action information of the part bone resource of the part needs to be calculated by invoking the underlying C++ function based on the part animation information.

In the foregoing operations 302 and 304-305, a possible implementation of configuring the part animation information of the part bone resource of the part based on the whole-body animation information of the whole-body bone resource is provided for each part of the virtual object. By controlling the part animation information of each part to directly inherit the whole-body animation information, consistency of animation behaviors of different parts of the virtual object is ensured (the part animation information all inheriting the whole-body animation information, and therefore being inevitably consistent). In this way, tedious calculation of setting animation behaviors for different child bone components is reduced, thereby improving calculation efficiency of the part animation information of each part of the virtual object. In another embodiment, another possible implementation may further be used to configure part animation information of a part bone resource of a part based on whole-body animation information of a whole-body bone resource.

306: The terminal loads an appearance resource of the part based on appearance resource indication information of the part, the appearance resource indication information indicating the appearance resource of the part.

In some embodiments, after the virtual object is divided into the plurality of parts based on the division manner indication information based on the description in operation 303, for each part of the virtual object, a technical person may pre-provide and create at least one appearance resource adapted to the part. For example, in an example, 10 wearable styles are provided for a part “waist ornament”, and then 10 appearance resources corresponding to the 10 styles are to be stored. In this way, increasing appearance performance service requirements can be fully satisfied. When a new style of a part is added, only an appearance resource of the new style needs to be created.

As shown in FIG. 11, an appearance resource management interface 1100 is provided. It may be seen that in the appearance resource management interface 1100, 2 appearance resources 1101-1102 are provided for a part “hair style”, 2 appearance resources 1103-1104 are provided for a part “head”, 5 appearance resources 1105, 1108, 1111, 1114, and 1117 are provided for a part “upper body”, 5 appearance resources 1106, 1109, 1112, 1115, and 1118 are provided for the part “lower body”, and 4 appearance resources 1107, 1110, 1113, and 1116 are provided for a part “shoe”. Each appearance resource may have its own unique appearance resource indication information. The appearance resource indication information is configured for uniquely identifying a corresponding appearance resource, and may be provided as a resource ID or a resource address of the appearance resource.

On this basis, since the virtual object has been divided into a plurality of parts, when the appearance resources of the virtual object are stored, an appearance resource (such as skin) of a whole body is not stored in units of virtual objects, but the appearance resource of each part is stored in units of parts of the virtual object. Therefore, to facilitate loading of the appearance resource, the appearance resource may be indicated through the appearance resource indication information, which greatly optimizes a management manner and a storage manner of the appearance resource.

In some embodiments, when the appearance resource of each part is loaded in a current picture frame, the terminal may determine to-be-loaded appearance resource indication information on the part, determine a resource address of the appearance resource based on the appearance resource indication information, then access the resource address, and load the appearance resource stored in the resource address. The foregoing operations are repeatedly performed until all parts of the virtual object are traversed. In this case, the appearance resources of all the parts can be loaded.

In some embodiments, the appearance resource indication information of each part is provided as a resource ID of a corresponding appearance resource. The terminal may determine a local resource address of the corresponding appearance resource based on a to-be-loaded resource ID on each part, and retrieve the appearance resource indicated by the resource ID from the local resource address, or apply, by using the to-be-loaded resource ID, to a server for the appearance resource indicated by the resource ID. A loading manner of the appearance resource is not specifically limited in the embodiments of the present disclosure.

Schematically, the appearance resource indication information of each part is provided as a resource address of a corresponding appearance resource. In this way, the terminal may directly access a resource address of a to-be-loaded appearance resource. In other words, an appearance resource stored in each resource address can be downloaded. The resource address may be a local storage path or an external uniform resource locator (URL). An information type of the appearance resource indication information is not specifically limited in the embodiments of the present disclosure.

In some embodiments, in the current picture frame, the terminal may further determine, from a plurality of parts of the virtual object, an item changing part having a change in appearance relative to a previous picture frame, and then load only the item changing appearance resource of the item changing part based on item changing resource indication information of the item changing part. The item changing resource indication information indicates an appearance resource of the item changing part after the item changing. In this way, for a part having no change in appearance, a new appearance resource does not need to be repeatedly loaded, and only a new appearance resource after the item changing needs to be loaded for the item changing part having a change in appearance, so that a resource loading logic of each picture frame in the real-time picture stream is optimized, thereby reducing the loading burden of the terminal, improving the loading efficiency of the virtual object, shortening the time consumed for rendering the virtual object, and reducing the probability of stuttering.

In an example, 10 wearable styles are provided for a part “waist ornament”, then 10 appearance resources corresponding to the 10 styles are to be stored, and 10 different resource IDs are assigned to the 10 appearance resources. In this way, when a user controls a virtual object to wear a waist ornament of a specified style A, the user does not need to load an appearance resource of a whole-body of the virtual object wearing the waist ornament of the style A, but keeps appearance resources of other parts of the virtual object unchanged, and only uses the resource ID of the waist ornament of the style A to additionally load an appearance resource specific to the style A of the part “waist ornament”, which saves overheads of loading appearance resources of other parts.

In some embodiments, since the appearance resource of each of the plurality of parts may need to be loaded in the current picture frame, a plurality of appearance resources may be loaded asynchronously, thereby avoiding a blocking problem caused by waiting timeout during synchronous loading, and further improving loading efficiency of the appearance resource. [00152]307: The terminal binds an appearance resource of the part to a child bone component of the part.

In some embodiments, in the case of asynchronous loading, a coroutine may be suspended on a game thread GameThread to implement asynchronous loading of appearance resources. The coroutine adds each to-be-loaded appearance resource indication information to a waiting queue. For each part of the virtual object, after the coroutine loads the appearance resource of the part based on the appearance resource indication information, the coroutine may transmit a callback notification to the game thread GameThread. After receiving the callback notification, the game thread GameThread may bind the loaded appearance resource to the child bone component of the part. The foregoing operations are repeatedly performed until all parts of the virtual object are traversed. In this case, appearance resources of all parts can be bound to respective corresponding child bone components.

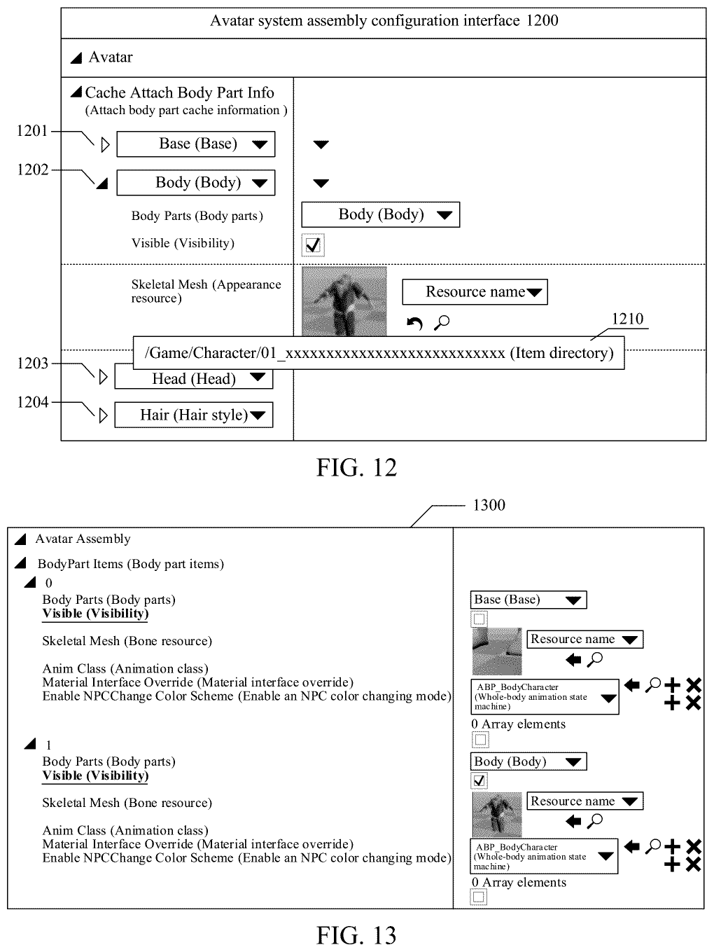

As shown in FIG. 12, in an Avatar system assembly configuration interface 1200, a parent bone component 1201 of a virtual object, a child bone component 1202 of a body part, a child bone component 1203 of a head part, and a child bone component 1204 of a hair style part are displayed in an assembly logic framework of the virtual object. A technical person may divide more or fewer parts based on business requirements. The child bone component 1202 of the body part is used as an example. It may be seen that a part type of the part is “Body”, an option Visible is checked to indicate that the part is visible, and the loaded appearance resource of the body part is displayed. A user can view an item directory 1210 of the appearance resource by clicking/tapping the appearance resource.

308: The terminal determines rendering pose information of the appearance resource in a current picture frame based on part animation information mounted by the child bone component.

In some embodiments, since a part bone resource, a part animation state machine, and an appearance resource of each part of the virtual object are all bound to a child bone component of the part, the virtual object is divided into a few parts, and a few child bone components are mounted on a parent bone component. For each child bone component, since the part animation state machine may generate the part animation information of the part based on the whole-body animation information in the whole-body animation state machine, the underlying C++ function may be driven to calculate the rendering pose information to be presented by the appearance resource in the current picture frame based on an animation behavior (or referred to as an animation state) indicated by the part animation information. For example, if the part animation information is “sprinting”, for the body part, rendering pose information (such as displacement, rotation, deformation to be presented by a coat in a “sprinting” state with respect to a previous picture frame) of the appearance resource (such as a coat) of the body part in the current picture frame needs to be calculated in real time based on the part animation information “sprinting”. The foregoing operations are repeatedly performed until all parts of the virtual object are traversed. In this case, the rendering pose information of the appearance resources of all the parts can be calculated.

309: The terminal conceals the whole-body bone resource.

In some embodiments, the terminal may determine rendering pose information of the parent bone component based on the whole-body animation information mounted on the parent bone component in the same manner as that in operation 308, and then conceal the rendering pose information of the parent bone component. In this way, since no any whole-body appearance resource is bound to the parent bone component and loaded, merely to ensure consistency of animation behaviors of different child bone components, the rendering pose information of the parent bone component is concealed by drawing a game picture, to avoid ghosting from rendering the virtual object, reduce rendering performance overheads, and ensure a good rendering effect.

As shown in FIG. 13, in a part assembly area 1300 of the Avatar system, it may be seen that an option Visible of a parent bone component of a Base type is not checked, i.e., the parent bone component is invisible. An option Visible of a child bone component of a body part of a Body type is checked, i.e., the child bone component of the body part is visible. By checking the option Visible of child bone components of all parts, and unchecking the option Visible of the parent bone component, concealing of rendering pose information of the parent bone component can be controlled, and drawing of the rendering pose information of all child bone components can be controlled.

310: The terminal renders an appearance resource of the part in the current picture frame based on the rendering pose information of each part, to control the appearance resource to perform an animation behavior following the part bone resource.

The appearance resources of the plurality of parts are assembled to form the animation behavior of the virtual object in the current picture frame.

In some embodiments, for each part of the virtual object, the appearance resource of the part may be rendered in the current picture frame based on the rendering pose information of the part, thereby implementing a visual effect that the appearance resource performs a corresponding animation behavior following the part bone resource. The foregoing operations are repeatedly performed until all parts of the virtual object are traversed. In this case, the appearance resources of all parts can be drawn in the current picture frame, and it is ensured that these appearance resources follow the rendering pose information of the corresponding parts. The appearance resources of all the parts are combined and assembled to form a visual effect that a whole body of the virtual object performs a corresponding animation behavior.

In some embodiments, for the current picture frame, since a plurality of virtual objects may exist in a virtual scene, but not all of the virtual objects are visible, a render thread RenderThread performs occlusion cull (OC) detection on each virtual object in the virtual scene, and for a virtual object (representing that the virtual object is visible within afield of view of the current picture frame) that passes the OC detection, a part bone resource, submits an appearance resource, and rendering pose information of each part of the virtual object to a render hardware interface thread (RHIThread). The RHIThread invokes a draw call (DC) interface provided by a graphics API supported by a GPU, and the DC interface commands the GPU to drive a rendering pipeline to render the appearance resource of each part of the virtual object, to obtain the current picture frame. The rendering pipeline includes a vertex shader, a rasterizer, and a pixel shader.

A rendering pipeline process of a certain part is described below. The RHIThread invokes the DC interface, and passes rendering pose information of the part to the vertex shader, so as to calculate a vertex attribute (such as coordinates, a color, a material, or a texture) of each vertex one by one in the part bone resource of the part. A result outputted by the vertex shader is inputted into the rasterizer. The rasterizer rasterizes the result, configures the result outputted by the vertex shader into discrete pixel points, and inputs the discrete pixel points into the pixel shader. The pixel shader performs shading calculation on the rasterized pixels, and outputs the shaded pixels to a frame buffer. In this way, the shaded pixels are displayed in the current picture frame. The foregoing operations are repeated until all pixels of the entire current picture frame are drawn.

In the foregoing operations 307-310, a possible implementation of concealing the whole-body bone resource and controlling the appearance resource to perform an animation behavior following the part bone resource based on the part animation information is provided. In this way, it is ensured that the appearance resource of each part can adapt to the animation behavior of the part to perform a pose change. Since the appearance resource of each part is assembled to form a whole-body appearance resource of the virtual object, and the whole-body appearance resource performs a whole, global, and consistent animation behavior, no behavior separation occurs between different parts of the virtual object, thereby ensuring smooth and natural transition and switching of animation behaviors. In another embodiment, another possible implementation may further be used to control the appearance resource to perform the animation behavior following the part bone resource based on the part animation information.

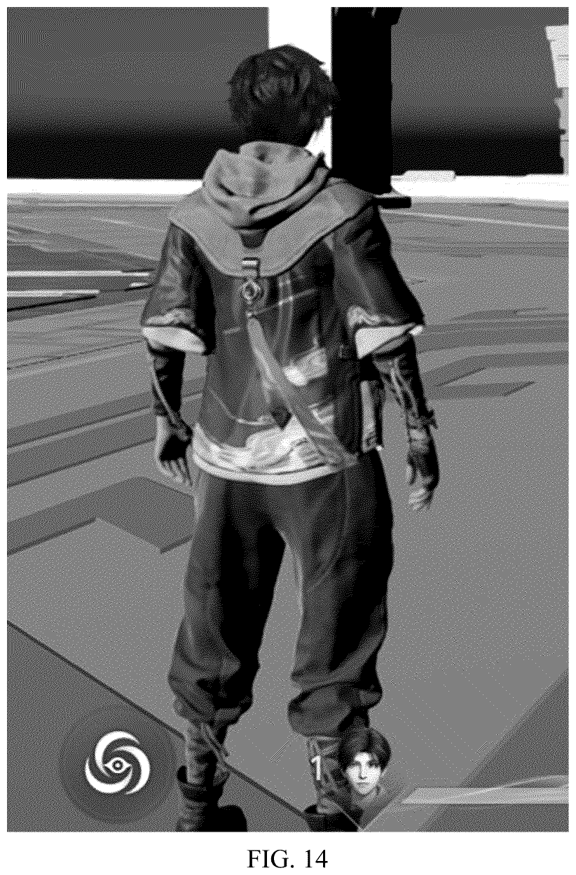

FIG. 14 shows a whole-body rendering effect is formed by splitting a virtual object into a plurality of parts, drawing appearance resources for all of the parts one by one, and assembling all of the parts after being drawn. It can be seen that each part in the whole-body rendering effect follows an animation behavior of “standing”, animation behaviors of all of the parts are kept consistent, and no behavior separation occurs between different parts of the virtual object, thereby ensuring smooth and natural transition and switching of animation behaviors.

Any combination of all of the foregoing optional solutions can be used to obtain an optional embodiment of the present disclosure, and the details are not described herein again.

According to the method provided in the embodiments of the present disclosure, the virtual object is split into a plurality of parts, a part bone resource is loaded for each part, and the part is independently controlled by using part animation information to perform an animation behavior. However, the part animation information inherits whole-body animation information, so that the animation behavior of each part is kept consistent with the animation behavior of the whole body. An appearance resource is loaded in units of parts. Pose adaptation is performed on the appearance resource by using the part animation information, so that the appearance resources of the parts are assembled to form an appearance resource of a whole-body of the virtual object. In this way, each picture frame in a real-time picture stream only needs to load an appearance resource having a change in appearance as required, thereby optimizing a resource loading logic of each picture frame, reducing a loading burden of a terminal, improving loading efficiency of the virtual object, shortening time consumed for rendering the virtual object, and reducing a probability of stuttering.

In the foregoing embodiments, a processing process of drawing any virtual object in any picture frame in a picture stream is described in detail. A whole-body bone resource of a virtual object is first split into a part bone resource of each of a plurality of parts, a child bone component and a part animation state machine are created for each part, and an appearance resource is bound. In a real-time rendering stage, only the appearance resources of the plurality of parts need to be dynamically assembled, so that the appearance performance of the virtual object can be dynamically assembled based on the appearance resource indication information of each part, and a smooth assembly display can be performed.

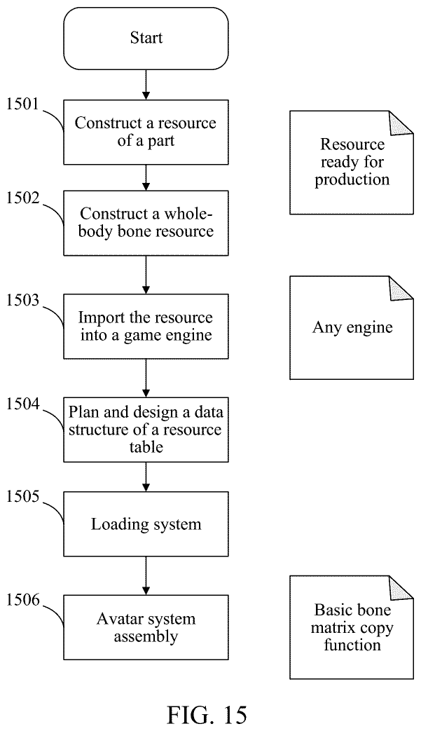

An Avatar system solution for dynamically assembling parts of a virtual object provided in the embodiments of the present disclosure is described by using examples below with reference to FIG. 15. The dynamic assembly of each part involved in the foregoing embodiments is implemented through the Avatar system.

Operation 1501: Construct an appearance resource and a part bone resource of each part of a virtual object.

Before construction, a technical person needs to first determine division manner indication information, determine, based on the division manner indication information, a plurality of parts into which the virtual object needs to be split, produce a part bone resource for each part in units of parts, and produce appearance resources of a plurality of styles for each part.

In a production stage, for example, an art designer produces appearance resources in units of parts by using a digital content creation (DCC) tool.

Operation 1502: Construct a complete whole-body bone resource of the virtual object.

Operation 1503: Import the whole-body bone resource, and the part bone resource and the appearance resource of each part into a game engine.

The game engine may be UE, Unity, or another engine, and an engine type is not limited herein.

In a generation stage, for example, an art designer produces a basic skeleton resource file: a whole-body bone resource and a part bone resource of each part, and imports the foregoing resources into the game engine.

Operation 1504: Plan and design a data structure of a resource table. To configure resources into the table for convenient management, each part (or a whole body) may be configured in the data structure: mesh resources, bone resources, animation state machine resources, and material resources (such as appearance resources).

Operation 1505: Implement asynchronous loading of various resources in the foregoing design resource table based on a loading system, for example, add various resources to an asynchronous loading queue, and wait for a resource loading callback notification of the loading system.

An appearance resource is used as an example. In the loading system, the appearance resource of each part may be asynchronously loaded based on appearance resource indication information (such as a resource ID). After the appearance resource of any part is asynchronously loaded, the loading system transmits a callback notification to a game thread.

Operation 1506: In each picture frame, the Avatar system performs underlying refresh setting on the various loaded resources included in the callback notification from the loading system, to replace original resources of old parts, so as to implement dynamic assembly of the Avatar system.

During the dynamic assembly of the Avatar system, a problem of setting an animation state machine of each part needs to be resolved. In the embodiments of the present disclosure, it needs to be ensured that a child bone component of each part in an animation system can copy bone matrix data of a parent bone component.

An animation inheritance process about each assembled part is described below, involving the following operations A1-A5:

A1: Construct a parent bone component BaseMeshComponent as a basic bone of a virtual object, the basic bone being configured to carry all actual data information of the virtual object, such as an animation behavior and a basic posture parameter of a character.

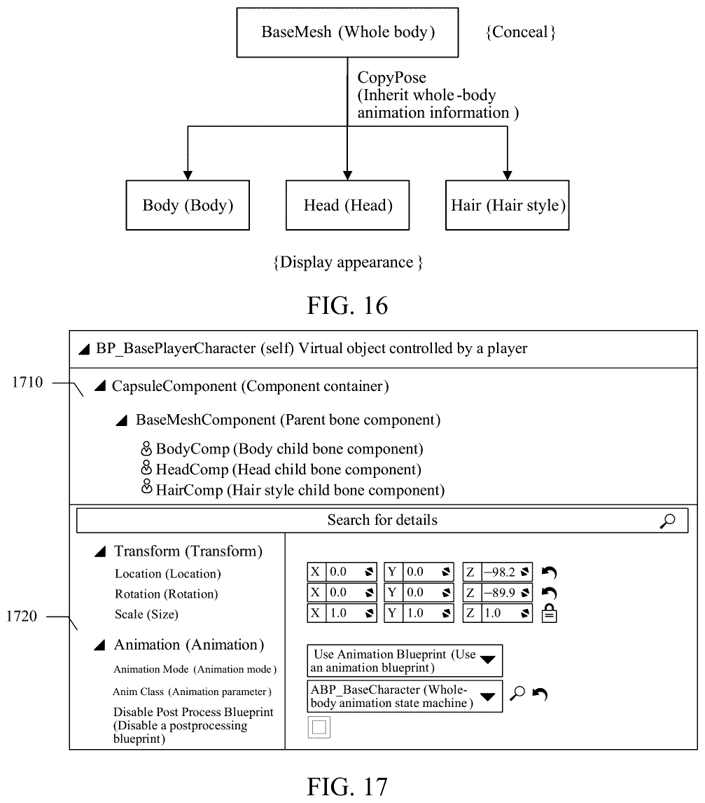

As shown in FIG. 16, in an assembly logic framework of a virtual object, it can be seen that a parent bone component BaseMeshComponent of the virtual object is used as a basic bone, and the remaining child bone components are all mounted on the parent bone component BaseMeshComponent.

A2: Construct a corresponding child bone component based on each part separated from the virtual object, and mount the child bone component on the parent bone component BaseMeshComponent.

FIG. 16 is still used as an example for description. Assuming that a virtual object is divided into three parts: a body, a head, and a hair style, a child bone component BodyComp of the body part, a child bone component HeadComp of the head part, and a child bone component HairComp of the hair style part are created, to form a parent bone component BaseMeshComponent on which 3 child bone components are mounted: BodyComp, HeadComp, and HairComp. The Avatar component of each part carrying the appearance resource is also bound to a corresponding child bone component (which is equivalent to being also attached to a child bone component to which the component is bound, and then is mounted on the parent bone component BaseMeshComponent).

A3: Mount a whole-body animation state machine (ABP) carrying whole-body animation information on the parent bone component BaseMeshComponent, to implement complete whole-body animation information based on the basic bone.

As shown in FIG. 17, a virtual object BP_BasePlayerCharacter (self) controlled by a player is used as an example for description. In a bone component architecture 1710 of the virtual object, in a component container (CapsuleComponent), a parent bone component BaseMeshComponent is involved, on which three child bone components are mounted: BodyComp, HeadComp, and HairComp.

In a parameter configuration bar 1720 of the parent bone component BaseMeshComponent, a location, rotation, and a scale of the parent bone component BaseMeshComponent in directions x, y, and z may be configured, and animation information of the parent bone component BaseMeshComponent may further be configured. For example, in an animation mode, “Use Animation Blueprint” is selected, and an animation state machine parameter (Anim Class) is configured as a whole-body animation state machine “ABP_BaseCharacter”.

A4: Customize an animation node in a part animation state machine of the child bone component, copy whole-body animation information of the whole-body animation state machine in real time, and pass the whole-body animation information to a blueprint of the part animation state machine.

An animation node of the part animation state machine needs to be implemented in the underlying C++ function, because the animation node carries calculation of basic bone information.

FIG. 16 is still used as an example for description. The 3 child bone components BodyComp, HeadComp, and HairComp all need to copy whole-body animation information (Copy Pose) from the parent bone component BaseMeshComponent.

A5: Conceal rendering pose information of the whole-body animation state machine, and display rendering pose information of each separated part animation state machine.

FIG. 16 is still used as an example for description. The parent bone component BaseMeshComponent is concealed, and an appearance resource of each of the 3 child bone components including BodyComp, HeadComp, and HairComp is drawn, to display an overall appearance of the virtual object.

Rendering pose information of a whole-body bone pose is concealed, and rendering pose information of the appearance resource of each part is drawn, so that a whole-body animation state machine based on a parent bone component can carry actual animation information, a part animation state machine of a child bone component is used to inherit part animation information, and complete appearance performance of the virtual object is assembled.

In the embodiments of the present disclosure, a basic bone having bone information, i.e., a parent bone component, is used as a main object, and a child bone component of another separated part is used as a child object. In this framework, the main object has basic animation information, and the child object does not have the basic animation information. However, during rendering, the child object inherits and uses the basic animation information of the basic bone, and all linked child bone components use the basic animation information of the parent bone component, to form a lightweight skeletal system. During running of each part, an appearance resource is asynchronously loaded through the Avatar system, and an assembly manner is dynamically set, to implement smooth switching of all parts, which not only improves flexibility of generating a virtual object, but also greatly enhances rendering performance. In addition, such a manner of inheriting basic animation information of the basic bone also resolves a problem of bloated reference of blueprint resources of a large number of virtual objects, and various resources of each part can be dynamically and synchronously loaded, to implement smooth assembly display during real-time rendering.

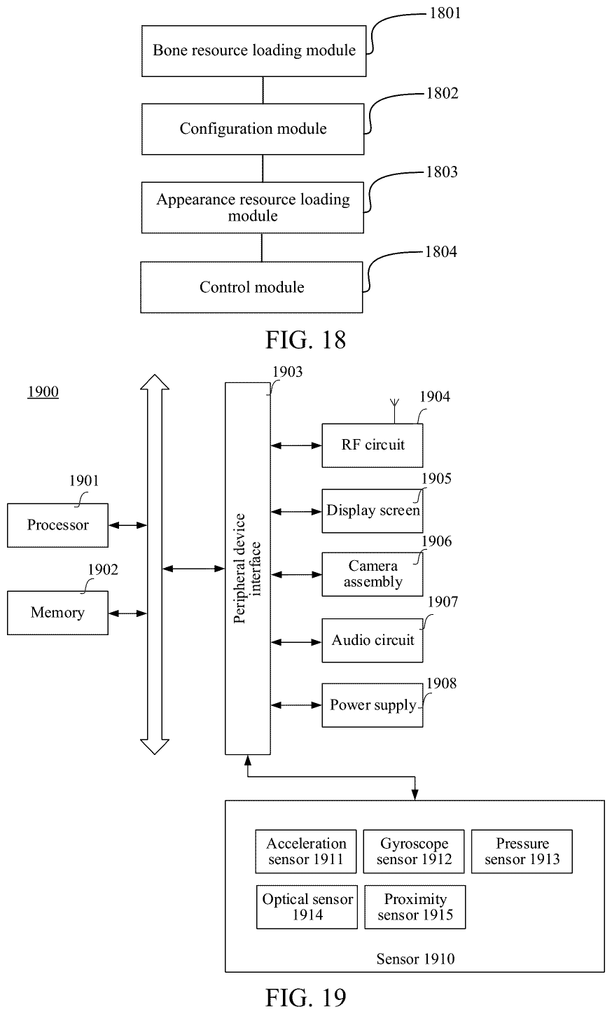

FIG. 18 is a schematic structural diagram of a virtual object control apparatus according to an embodiment of the present disclosure. Referring to FIG. 18, the apparatus includes:
a bone resource loading module 1801, configured to load a whole-body bone resource of a virtual object and a part bone resource of each of a plurality of parts;
a configuration module 1802, configured to configure, for each part, part animation information of the part bone resource of the part based on whole-body animation information of the whole-body bone resource, the part animation information inheriting an animation behavior of the part in the whole-body animation information;
an appearance resource loading module 1803, configured to load an appearance resource of the part based on appearance resource indication information of the part, the appearance resource indication information indicating the appearance resource of the part; and
a control module 1804, configured to conceal the whole-body bone resource, and control, based on the part animation information, the appearance resource to perform an animation behavior following the part bone resource.

According to the apparatus provided in the embodiments of the present disclosure, the virtual object is split into a plurality of parts, a part bone resource is loaded for each part, and the part is independently controlled by using part animation information to perform an animation behavior. However, the part animation information inherits whole-body animation information, so that the animation behavior of each part is kept consistent with the animation behavior of the whole body. An appearance resource is loaded in units of parts. Pose adaptation is performed on the appearance resource by using the part animation information, so that the appearance resources of the parts are assembled to form an appearance resource of a whole-body of the virtual object. In this way, each picture frame in a real-time picture stream only needs to load an appearance resource having a change in appearance as required, thereby optimizing a resource loading logic of each picture frame, reducing a loading burden of a terminal, improving loading efficiency of the virtual object, shortening time consumed for rendering the virtual object, and reducing a probability of stuttering.

In some embodiments, the bone resource loading module 1801 is configured to:
create a parent bone component, and import the whole-body bone resource into the parent bone component; and
mount, for each part, a child bone component of the part on the parent bone component, and import the part bone resource of the part into the child bone component.

In some embodiments, the configuration module 1802 is configured to:
create a whole-body animation state machine, and mount the whole-body animation state machine on the parent bone component, the whole-body animation state machine being configured to control an animation behavior of the virtual object;
create a part animation state machine of the part, and mount the part animation state machine on the child bone component, the part animation state machine being configured to control an animation behavior of the part of the virtual object; and
pass the whole-body animation information carried by the whole-body animation state machine to the part animation state machine, to generate the part animation information.

In some embodiments, the control module 1804 is configured to:
bind, for each part, an appearance resource of the part to a child bone component of the part;
determine rendering pose information of the appearance resource in a current picture frame based on part animation information mounted by the child bone component; and
render an appearance resource of the part in the current picture frame based on the rendering pose information of each part, appearance resources of the plurality of parts being assembled to form an animation behavior of the virtual object in the current picture frame.

In some embodiments, the control module 1804 is further configured to:
conceal rendering pose information of the parent bone component, the rendering pose information of the parent bone component being determined based on the whole-body animation information.

In some embodiments, based on the composition of the apparatus in FIG. 18, the apparatus further includes:
a division module, configured to divide the virtual object into the plurality of parts based on division manner indication information; and
a creation module, configured to create, for each part, at least one appearance resource adapted to the part.

In some embodiments, the bone resource loading module 1801 is configured to:
determine, based on a species type of the virtual object, an initial bone resource of the species type; and
configure the initial bone resource based on a posture parameter of the virtual object, to obtain the whole-body bone resource.

In some embodiments, the appearance resource loading module 1803 is configured to:
determine a resource address of the appearance resource based on the appearance resource indication information; and
access the resource address, and load the appearance resource stored in the resource address.

In some embodiments, the appearance resource loading module 1803 is further configured to:
determine, from a plurality of parts of the virtual object by the electronic device in a current picture frame, an item changing part having a change in appearance with respect to a previous picture frame; and
load an item changing appearance resource of the item changing part based on item changing resource indication information of the item changing part, the item changing resource indication information indicating an appearance resource of the item changing part after the item changing.

Any combination of all of the foregoing optional solutions can be used to obtain an optional embodiment of the present disclosure, and the details are not described herein again.

When the virtual object control apparatus provided in the foregoing embodiments controls and displays the virtual object, only division of the functional modules is described by using examples. In practical application, the functions can be completed by different functional modules as required. To be specific, an internal structure of an electronic device is divided into different functional modules to complete all or part of the functions described above. In addition, the virtual object control apparatus provided in the foregoing embodiments and the embodiment of the virtual object control method belong to the same idea. For details of an implementation process, reference is made to the embodiments of the virtual object control method. The details are not described herein again.

FIG. 19 is a schematic structural diagram of an electronic device according to an embodiment of the present disclosure. As shown in FIG. 19, an example in which the electronic device is a terminal 1900 is used for description. In some embodiments, a device type of the terminal 1900 includes: a smartphone, a tablet computer, a moving picture experts group audio layer III (MP3) player, a moving picture experts group audio layer IV (MP4) player, a notebook computer, or a desktop computer. The terminal 1900 may also be referred to as another name such as user equipment, a portable terminal, a laptop terminal, or a desktop terminal.

The terminal 1900 usually includes a processor 1901 and a memory 1902.

In some embodiments, the processor 1901 includes one or more processing cores, for example, a 4-core processor or an 8-core processor. In some embodiments, the processor 1901 is implemented by using at least one of the following hardware forms including digital signal processing (DSP), a field-programmable gate array (FPGA), and a programmable logic array (PLA). In some embodiments, the processor 1901 includes a main processor and a coprocessor. The main processor is a processor configured to process data in an awake state, and is also referred to as a CPU. The coprocessor is a low-power processor configured to process data in a standby state. In some embodiments, the processor 1901 has a GPU integrated therein. The GPU is configured to render and draw content that needs to be displayed on a display. In some embodiments, the processor 1901 further includes an artificial intelligence (AI) processor. The A1 processor is configured to process computing operations related to machine learning.

In some embodiments, the memory 1902 includes one or more computer-readable storage media. In some embodiments, the computer-readable storage medium is non-transient. In some embodiments, the memory 1902 further includes a high-speed random access memory (RAM) and a non-volatile memory, for example, one or more disk storage devices and flash storage devices. In some embodiments, the non-transient computer-readable storage medium in the memory 1902 is configured to store at least one program code. The at least one program code is configured to be executed by the processor 1901 to implement the virtual object control method provided in various embodiments of the present disclosure.

In some embodiments, the terminal 1900 further includes a peripheral device interface 1903 and at least one peripheral device. The processor 1901, the memory 1902, and the peripheral device interface 1903 can be connected through a bus or a signal line. Each peripheral device can be connected to the peripheral device interface 1903 through a bus, a signal line, or a circuit board. Specifically, the peripheral device includes at least one of a radio frequency (RF) circuit 1904, a display screen 1905, a camera assembly 1906, an audio circuit 1907, and a power supply 1908.

The peripheral device interface 1903 may be configured to connect the at least one peripheral device related to input/output (I/O) to the processor 1901 and the memory 1902. In some embodiments, the processor 1901, the memory 1902, and the peripheral interface 1903 are integrated on the same chip or the same circuit board. In some other embodiments, any one or two of the processor 1901, the memory 1902, and the peripheral device interface 1903 are implemented on an independent chip or circuit board, which is not limited in this embodiment.

The RF circuit 1904 is configured to receive and transmit an RF signal, which is also referred to as an electromagnetic signal. The RF circuit 1904 communicates with a communication network and another communication device through the electromagnetic signal. The RF circuit 1904 converts an electrical signal into an electromagnetic signal for transmission, or converts a received electromagnetic signal into an electrical signal. In some embodiments, the RF circuit 1904 includes an antenna system, an RF transceiver, one or more amplifiers, a tuner, an oscillator, a DSP, a codec chipset, a user identity module card, and the like. In some embodiments, the RF circuit 1904 communicates with another terminal through at least one wireless communication protocol. The wireless communication protocol includes but is not limited to a metropolitan area network, various generations of mobile communication networks (2G, 3G, 4G, and 5G), a wireless local area network, and/or a wireless fidelity (Wi-Fi) network. In some embodiments, the RF circuit 1904 further includes a near field communication (NFC)-related circuit, which is not limited in the present disclosure.

The display screen 1905 is configured to display a user interface (UI). In some embodiments, the UI includes a graph, texts, an icon, a video, and any combination thereof. When the display screen 1905 is a touch display screen, the display screen 1905 further has a capability of collecting a touch signal on or above a surface of the display screen 1905. The touch signal can be inputted to the processor 1901 as a control signal for processing. In some embodiments, the display screen 1905 is further configured to provide a virtual button and/or a virtual keyboard, which are/is also referred to as a soft button and/or a soft keyboard. In some embodiments, one display screen 1905 is arranged on a front panel of the terminal 1900. In some other embodiments, at least two display screens 1905 are respectively arranged on different surfaces of the terminal 1900 or are folded. In some embodiments, the display screen 1905 is a flexible display screen arranged on a curved surface or a folded surface of the terminal 1900. Even, in some embodiments, the display screen 1905 is arranged as a non-rectangular irregular figure, i.e., a special-shaped screen. In some embodiments, the display screen 1905 is manufactured by using a liquid crystal display (LCD), an organic light-emitting diode (OLED), or the like.

The camera assembly 1906 is configured to collect an image or a video. In some embodiments, the camera assembly 1906 includes a front camera and a rear camera. Generally, the front camera is arranged on the front panel of the terminal, and the rear camera is arranged on the back of the terminal. In some embodiments, at least two rear cameras are arranged, which are respectively any of a main camera, a depth-of-field camera, a wide-angle camera, and a telephoto camera, to achieve background blurring through fusion of the main camera and the depth-of-field camera, panoramic photographing and virtual reality (VR) photographing through fusion of the main camera and the wide-angle camera, or another fusion photographing function. In some embodiments, the camera assembly 1906 further includes a flash. In some embodiments, the flash is a single-color-temperature flash, or is a dual-color-temperature flash. The dual-color-temperature flash is a combination of a warm flash and a cold flash, which is configured for light compensation at different color temperatures.

In some embodiments, the audio circuit 1907 includes a microphone and a speaker. The microphone is configured to collect sound waves of a user and an environment, and convert the sound waves into electrical signals and input the electrical signals to the processor 1901 for processing, or input the electrical signals to the RF circuit 1904 to implement voice communication. For the purpose of stereo collection or noise reduction, a plurality of microphones are respectively arranged at different parts of the terminal 1900. In some embodiments, the microphone is an array microphone or an omnidirectional collection microphone. The speaker is configured to convert the electrical signal from the processor 1901 or the RF circuit 1904 into sound waves. In some embodiments, the speaker is a conventional film speaker, or is a piezoelectric ceramic speaker. When the speaker is the piezoelectric ceramic speaker, the speaker not only can convert an electric signal into the sound wave audible to human, but also can convert the electric signal into the sound wave inaudible to the human for purposes such as ranging. In some embodiments, the audio circuit 1907 further includes a headphone jack.

The power supply 1908 is configured to supply power to components in the terminal 1900. In some embodiments, the power supply 1908 is an alternating current battery, a direct current battery, a disposable battery, or a rechargeable battery. When the power supply 1908 includes a rechargeable battery, the rechargeable battery supports wired charging or wireless charging. The rechargeable battery is further configured to support a fast charging technology.

In some embodiments, the terminal 1900 further includes one or more sensors 1910. The one or more sensors 1910 include but are not limited to: an acceleration sensor 1911, a gyroscope sensor 1912, a pressure sensor 1913, an optical sensor 1914, and a proximity sensor 1915.

In some embodiments, the acceleration sensor 1911 detects a magnitude of acceleration on three coordinate axes of a coordinate system established by using the terminal 1900. For example, the acceleration sensor 1911 is configured to detect components of acceleration of gravity on the three coordinate axes. In some embodiments, the processor 1901 controls, based on a gravity acceleration signal collected by the acceleration sensor 1911, the display screen 1905 to display the UI in a landscape view or a portrait view. The acceleration sensor 1911 is further configured to collect movement data of a game or a user.

In some embodiments, the gyroscope sensor 1912 detects a body direction and a rotation angle of the terminal 1900. The gyroscope sensor 1912 cooperates with the acceleration sensor 1911 to collect a 3D action performed by the user on the terminal 1900. The processor 1901 implements the following functions based on the data collected by the gyroscope sensor 1912: movement sensing (for example, changing the UI based on a tilt operation of the user), image stabilization during shooting, game control, and inertial navigation.

In some embodiments, the pressure sensor 1913 is arranged on a side frame of the terminal 1900 and/or a lower layer of the display screen 1905. When the pressure sensor 1913 is arranged on the side frame of the terminal 1900, a holding signal of the user on the terminal 1900 can be detected. The processor 1901 performs left/right hand recognition or a quick operation based on the holding signal collected by the pressure sensor 1913. When the pressure sensor 1913 is arranged on the lower layer of the display screen 1905, the processor 1901 controls, based on a pressure operation performed by the user on the display screen 1905, an operable control on the UI. The operable control includes at least one of a button control, a scroll-bar control, an icon control, and a menu control.

The optical sensor 1914 is configured to collect ambient light intensity. In an embodiment, the processor 1901 controls display brightness of the display screen 1905 based on the ambient light intensity collected by the optical sensor 1914. Specifically, when the ambient light intensity is relatively high, the display brightness of the display screen 1905 is increased. When the ambient light intensity is relatively low, the display brightness of the display screen 1905 is reduced. In another embodiment, the processor 1901 further dynamically adjusts a shooting parameter of the camera assembly 1906 based on the ambient light intensity collected by the optical sensor 1914.

The proximity sensor 1915, also referred to as a distance sensor, is usually arranged on the front panel of the terminal 1900. The proximity sensor 1915 is configured to collect a distance between the user and the front of the terminal 1900. In an embodiment, when the proximity sensor 1915 detects that the distance between the user and the front side of the terminal 1900 gradually decreases, the processor 1901 controls the display screen 1905 to be switched from a screen-on state to a screen-off state. When the proximity sensor 1915 detects that the distance between the user and the front of the terminal 1900 gradually increases, the processor 1901 controls the display screen 1905 to be switched from the screen-off state to the screen-on state.

A person skilled in the art can understand that the structure shown in FIG. 19 does not constitute a limitation on the terminal 1900. The terminal can include more or fewer components than those shown in the figure, or some merged components, or different component arrangements.

In an exemplary embodiment, a computer-readable storage medium is further provided, for example, a memory including at least one computer program. The foregoing at least one computer program may be executed by a processor in an electronic device to perform the virtual object control method in the foregoing embodiments. For example, the computer-readable storage medium includes a read-only memory (ROM), a RAM, a compact disc read-only memory (CD-ROM), a magnetic tape, a floppy disk, an optical data storage device, and the like.

In an exemplary embodiment, a computer program product is further provided, including one or more computer programs, the one or more computer programs being stored in a computer-readable storage medium. One or more processors of an electronic device can read the one or more computer programs from the computer-readable storage medium, the one or more processors executing the one or more computer programs, so that the electronic device can perform the virtual object control method in the foregoing embodiments.

A person of ordinary skill in the art can understand that all or part of the operations of implementing the foregoing embodiments can be performed by hardware, or can be performed by a program instructing relevant hardware. In some embodiments, the program is stored in a computer-readable storage medium. In some embodiments, the storage medium mentioned above is a ROM, a magnetic disk, an optical disc, or the like.

The foregoing descriptions are merely optional embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A virtual object control method, comprising:
loading, by an electronic device, a whole-body bone resource of a virtual object and a part bone resource of each of a plurality of parts of the virtual object;
configuring, by the electronic device for each part and based on whole-body animation information of the whole-body bone resource, part animation information of the part bone resource of the part, the part animation information inheriting an animation behavior of the part in the whole-body animation information;
loading, by the electronic device and based on appearance resource indication information of the part, an appearance resource of the part;
concealing, by the electronic device, the whole-body bone resource; and
controlling, by the electronic device and based on the part animation information, the appearance resource to perform an animation behavior following the part bone resource.

2. The method according to claim 1, wherein the loading, by the electronic device, the whole-body bone resource of the virtual object and the part bone resource of each of the plurality of parts of the virtual object comprises:
creating, by the electronic device, a parent bone component;
importing, by the electronic device, the whole-body bone resource into the parent bone component;
mounting, by the electronic device for each part, a child bone component of the part on the parent bone component; and
importing, by the electronic device, the part bone resource of the part into the child bone component.

3. The method according to claim 2, wherein the configuring, by the electronic device for each part and based on the whole-body animation information of the whole-body bone resource, the part animation information of the part bone resource of the part comprises:
creating, by the electronic device, a whole-body animation state machine;
mounting, by the electronic device, the whole-body animation state machine on the parent bone component, the whole-body animation state machine being configured to control an animation behavior of the virtual object;
creating, by the electronic device, a part animation state machine of the part;
mounting, by the electronic device, the part animation state machine on the child bone component, the part animation state machine being configured to control an animation behavior of the part of the virtual object; and
passing, by the electronic device, the whole-body animation information carried by the whole-body animation state machine to the part animation state machine, to generate the part animation information.

4. The method according to claim 2, wherein the controlling, by the electronic device and based on the part animation information, the appearance resource to perform the animation behavior following the part bone resource comprises:
binding, by the electronic device for each part, an appearance resource of the part to a child bone component of the part;
determining, by the electronic device and based on part animation information mounted by the child bone component, rendering pose information of the appearance resource in a current picture frame; and
rendering, by the electronic device and based on the rendering pose information of each part, an appearance resource of the part in the current picture frame, appearance resources of the plurality of parts being assembled to form an animation behavior of the virtual object in the current picture frame.

5. The method according to claim 4, wherein the concealing, by the electronic device, the whole-body bone resource comprises:
concealing, by the electronic device, rendering pose information of the parent bone component, the rendering pose information of the parent bone component being determined based on the whole-body animation information.

6. The method according to claim 1, further comprising:
dividing, by the electronic device and based on division manner indication information, the virtual object into the plurality of parts; and
creating, by the electronic device for each part, at least one appearance resource adapted to the part.

7. The method according to claim 1, wherein the loading, by the electronic device, the whole-body bone resource of the virtual object comprises:
determining, by the electronic device and based on a species type of the virtual object, an initial bone resource of the species type; and
configuring, by the electronic device and based on a posture parameter of the virtual object, the initial bone resource to obtain the whole-body bone resource.

8. The method according to claim 1, wherein the loading, by the electronic device and based on the appearance resource indication information of the part, the appearance resource of the part comprises:
determining, by the electronic device and based on the appearance resource indication information, a resource address of the appearance resource;
accessing, by the electronic device, the resource address; and
loading, by the electronic device, the appearance resource stored in the resource address.

9. The method according to claim 1, further comprising:
determining, by the electronic device and from a plurality of parts of the virtual object in a current picture frame, an item changing part having a change in appearance with respect to a previous picture frame; and
loading, by the electronic device and based on item changing resource indication information of the item changing part, an item changing appearance resource of the item changing part, the item changing resource indication information indicating an appearance resource of the item changing part after the item changing.

10. A non-transitory computer-readable medium, having computer-executable instructions stored thereon, the computer-executable instructions, when executed by one or more processors of a virtual object control apparatus, cause the virtual object control apparatus to facilitate:
loading a whole-body bone resource of a virtual object and a part bone resource of each of a plurality of parts of the virtual object;
configuring, for each part and based on whole-body animation information of the whole-body bone resource, part animation information of the part bone resource of the part, the part animation information inheriting an animation behavior of the part in the whole-body animation information;
loading, based on appearance resource indication information of the part, an appearance resource of the part;
concealing the whole-body bone resource; and
controlling, based on the part animation information, the appearance resource to perform an animation behavior following the part bone resource.

11. An electronic device, comprising:
one or more processors; and
memory storing instructions that, when executed by the one or more processors, cause the electronic device to:
load a whole-body bone resource of a virtual object and a part bone resource of each of a plurality of parts of the virtual object;
configure, for each part and based on whole-body animation information of the whole-body bone resource, part animation information of the part bone resource of the part, the part animation information inheriting an animation behavior of the part in the whole-body animation information;
load, based on appearance resource indication information of the part, an appearance resource of the part;
conceal the whole-body bone resource; and
control, based on the part animation information, the appearance resource to perform an animation behavior following the part bone resource.

12. The electronic device according to claim 11, wherein the instructions, when executed by the one or more processors, cause the electronic device to:
create a parent bone component;
import the whole-body bone resource into the parent bone component;
mount, for each part, a child bone component of the part on the parent bone component; and
import the part bone resource of the part into the child bone component.

13. The electronic device according to claim 12, wherein the instructions, when executed by the one or more processors, cause the electronic device to:
create a whole-body animation state machine;
mount the whole-body animation state machine on the parent bone component, the whole-body animation state machine being configured to control an animation behavior of the virtual object;
create a part animation state machine of the part;
mount the part animation state machine on the child bone component, the part animation state machine being configured to control an animation behavior of the part of the virtual object; and
pass the whole-body animation information carried by the whole-body animation state machine to the part animation state machine, to generate the part animation information.

14. The electronic device according to claim 12, wherein the instructions, when executed by the one or more processors, cause the electronic device to:
bind, for each part, an appearance resource of the part to a child bone component of the part;
determine, based on part animation information mounted by the child bone component, rendering pose information of the appearance resource in a current picture frame; and
render, based on the rendering pose information of each part, an appearance resource of the part in the current picture frame, appearance resources of the plurality of parts being assembled to form an animation behavior of the virtual object in the current picture frame.

15. The electronic device according to claim 14, wherein the instructions, when executed by the one or more processors, cause the electronic device to:
conceal rendering pose information of the parent bone component, the rendering pose information of the parent bone component being determined based on the whole-body animation information.

16. The electronic device according to claim 11, wherein the instructions, when executed by the one or more processors, further cause the electronic device to:
divide, based on division manner indication information, the virtual object into the plurality of parts; and
create, for each part, at least one appearance resource adapted to the part.

17. The electronic device according to claim 11, wherein the instructions, when executed by the one or more processors, cause the electronic device to:
determine, based on a species type of the virtual object, an initial bone resource of the species type; and
configure, based on a posture parameter of the virtual object, the initial bone resource to obtain the whole-body bone resource.

18. The electronic device according to claim 11, wherein the instructions, when executed by the one or more processors, cause the electronic device to:
determine, based on the appearance resource indication information, a resource address of the appearance resource;
access the resource address; and
load the appearance resource stored in the resource address.

19. The electronic device according to claim 11, wherein the instructions, when executed by the one or more processors, further cause the electronic device to:
determine, from a plurality of parts of the virtual object in a current picture frame, an item changing part having a change in appearance with respect to a previous picture frame; and
load, based on item changing resource indication information of the item changing part, an item changing appearance resource of the item changing part, the item changing resource indication information indicating an appearance resource of the item changing part after the item changing.

20. The non-transitory computer-readable medium according to claim 10, wherein the computer-executable instructions further cause the virtual object control apparatus to facilitate:
creating a parent bone component;
importing the whole-body bone resource into the parent bone component;
mounting, for each part, a child bone component of the part on the parent bone component; and
importing the part bone resource of the part into the child bone component.
